(19) United States
(12) Patent Application Publication
(10) Pub. No.: US 2024/0106532 A1
(43) Pub. Date: Mar. 28, 2024

(54) BACKSCATTER COMMUNICATIONS

(71) Applicant: INTERDIGITAL PATENT HOLDINGS, INC., Wilmington, DE (US)

(72) Inventors: Nagi Mahalingam, San Diego, CA (US); Ravikumar Pragada, Warrington, PA (US); Tanbir Haque, Jackson Heights, NY (US); Hussain Elkotby, Conshohocken, PA (US)

(73) Assignee: INTERDIGITAL PATENT HOLDINGS, INC., Wilmington, DE (US)

(21) Appl. No.: 18/276,293

(22) PCT Filed: Feb. 8, 2022
(86) PCT No.: PCT/US2022/015678

§ 371 Date: Aug. 8, 2023

Related U.S. Application Data
(60) Provisional application No. 63/147,079, filed on Feb. 8, 2021.
(60) Provisional application No. 63/235,469, filed on Aug. 20, 2021.

(51) Int. Cl. H04B 7/22; H04W 52/02; H04W 72/044; H04W 72/543

(52) U.S. Cl. CPC H04B 7/22; H04W 52/0216; H04W 72/0473; H04W 72/543

(57) ABSTRACT

Systems, methods, and devices for wireless transmissions based on backscattering. A backscatter indication message (BID) is received from an access point (AP). An interrogation signal is received. Uplink data is transmitted to the AP based on the BID and the interrogation signal. In some implementations, the interrogation signal is received from the AP. In some implementations, the BID indicates a backscatter duration, and the uplink data is transmitted to the AP for the backscatter duration. In some implementations, the uplink data is transmitted to the AP concurrently with receiving the interrogation signal. In some implementations, energy is harvested from the interrogation signal. In some implementations, the uplink data is transmitted to the AP subsequent to the interrogation signal, based on the energy harvested from the interrogation signal. In some implementations, the interrogation signal includes a compensation signal based on channel conditions and/or based on backscattering from the WTRU.

### CROSS-REFERENCE TO RELATED APPLICATIONS

This application claims the benefit of U.S. Provisional Application No. 63/147,079 filed Feb. 8, 2021, and U.S. Provisional Application No. 63/235,469 filed Aug. 20, 2021, the contents of which are incorporated herein by reference.

### BACKGROUND

Power saving functions are implemented in IEEE and 3GPP standards for end-user devices in order to save power on the device. Backscattering transmitters reflect or absorb incident waveforms to mimic on-off keying.

### SUMMARY

Some implementations provide systems, methods, and/or devices for wireless transmissions based on backscattering. A backscatter indication message (BID) is received from an access point (AP). An interrogation signal is received. Uplink data is transmitted to the AP based on the BID and the interrogation signal. In some implementations, the interrogation signal is received from the AP. In some implementations, the BID indicates a backscatter duration, and the uplink data is transmitted to the AP for the backscatter duration. In some implementations, the uplink data is transmitted to the AP concurrently with receiving the interrogation signal. In some implementations, energy is harvested from the interrogation signal. In some implementations, the uplink data is transmitted to the AP subsequent to the interrogation signal, based on the energy harvested from the interrogation signal. In some implementations, the interrogation signal includes a compensation signal based on channel conditions and/or based on backscattering from the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a chart illustrating example backscattering in 802.11ah framework;

FIG. 3 is a table describing an example BID message format;

FIG. 4 is a block diagram illustrating example messages and associated formats;

FIG. 5 is a diagram illustrating example backscattering in 802.11 systems;

FIG. 6A illustrates example energy harvesting and backscattering;

FIG. 6B is a continuation of the illustration in FIG. 6A;

FIG. 7 illustrates example communications enabling backscatter communications in 802.11ax systems;

FIG. 8 is a flow chart illustrating operation of a BSTA where a DL received signal is above or below a first threshold based on a QoS requirement;

FIG. 9 is a system diagram illustrating example interference in backscattering transmissions;

FIG. 10 illustrates an example framework for learning DL channel conditions via reverse estimation;

FIG. 11 illustrates transmit-side compensation of channel impairments;

FIG. 12 illustrates an example control loop at the AP for channel estimation;

FIG. 13 illustrates an example control loop for multi-carrier, multi-STA estimation; and

FIG. 14 illustrates example buffer estimation of a BSTA by an AP.

### DETAILED DESCRIPTION

Some implementations provide a method implemented in a wireless station STA. The STA receives a backscatter indication (BID) message that indicates a backscattering opportunity and a downlink (DL) signal strength threshold. The STA backscatters a DL transmission, received on a resource unit (RU) indicated in the BID message, to generate a backscatter transmission, based on a signal strength of the DL transmission exceeding the DL signal strength threshold.

In some implementations, the backscattering of the DL transmission occurs based on a duration of the DL signal exceeding a payload transmission requirement associated with the backscatter transmission. Some implementations include backscattering an uplink (UL) transmission from another STA, received on a resource unit indicated in the BID message, to generate another backscatter transmission, based on a strength of the DL transmission not exceeding the DL signal strength threshold. In some implementations, the backscattering the UL transmission occurs based on a signal strength of the UL transmission exceeding an UL signal strength threshold, and a duration of the UL transmission exceeding a payload transmission requirement associated with the other backscatter transmission. Some implementations include measuring a signal strength of the DL transmission based on the BID message, a preamble in a DL frame, or a dedicated reference signal. In some implementations, the DL signal strength threshold and the UL signal strength threshold are a same threshold. In some implementations, the BID message includes a management message. In some implementations, the BID message includes an acknowledgement message. In some implementations, the DL signal strength threshold is associated with a quality of service (QoS). In some implementations, the backscatter transmission is generated based on a signal strength of the DL transmission exceeding the DL signal strength threshold and the DL transmission exceeding a payload transmission requirement.

Some implementations provide a STA. The STA includes a receiver configured to receive a BID message that indicates a backscattering opportunity and a DL signal strength threshold. The STA also includes a transmitter configured to backscatter a DL transmission, received on a RU indicated in the BID message, to generate a backscatter transmission, based on a signal strength of the DL transmission exceeding the DL signal strength threshold.

In some implementations, the transmitter is also configured to backscatter the DL transmission based on a duration of the DL signal exceeding a payload transmission requirement associated with the backscatter transmission. In some implementations, the transmitter is also configured to backscatter a UL transmission from another STA, received on a resource unit indicated in the BID message, to generate another backscatter transmission, based on a strength of the DL transmission not exceeding the DL signal strength threshold. In some implementations, the transmitter is also configured to backscatter the UL transmission based on a signal strength of the UL transmission exceeding an UL signal strength threshold, and a duration of the UL transmission exceeding a payload transmission requirement associated with the other backscatter transmission. In some implementations, the receiver is also configured to measure a signal strength of the DL transmission based on the BID message, a preamble in a DL frame, or a dedicated reference signal. In some implementations, the DL signal strength threshold and the UL signal strength threshold are a same threshold. In some implementations, the BID message includes a management message. In some implementations, the BID message includes an acknowledgement message. In some implementations, the DL signal strength threshold is associated with a QoS. In some implementations, the transmitter is also configured to generate the backscatter transmission based on a signal strength of the DL transmission exceeding the DL signal strength threshold and the DL transmission exceeding a payload transmission requirement.

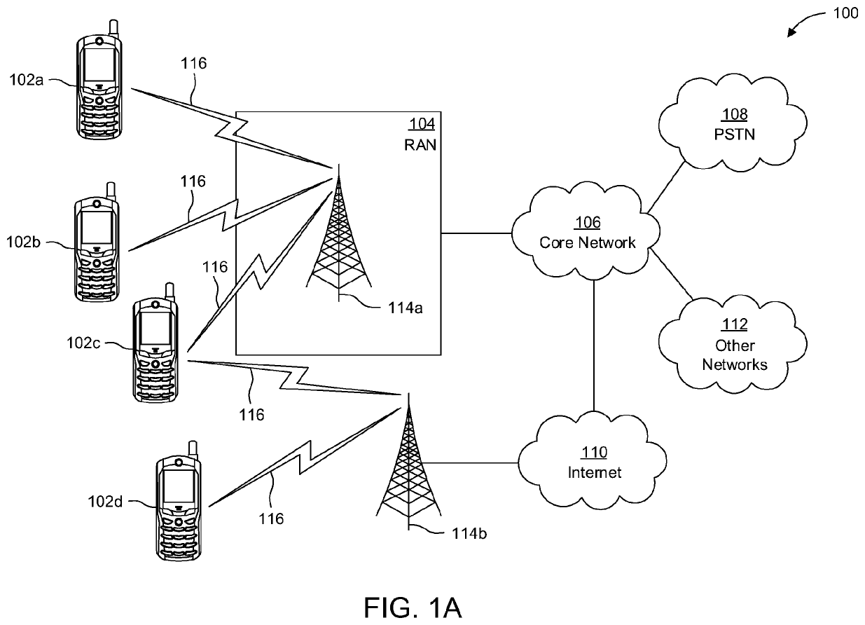

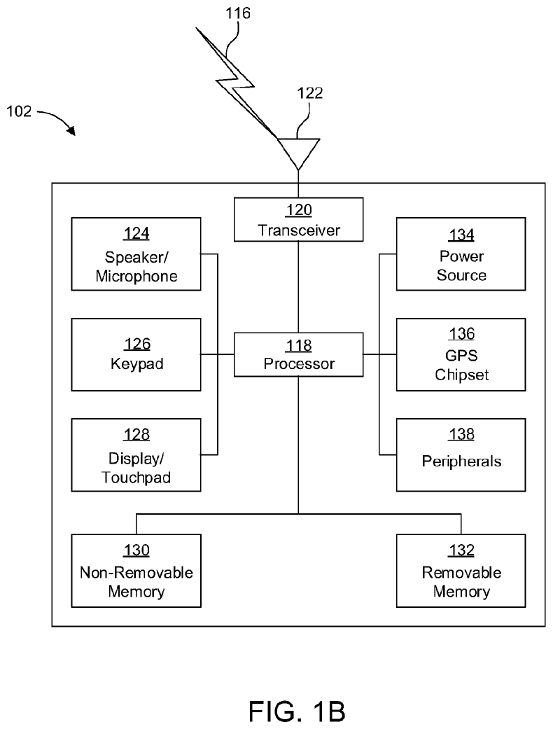

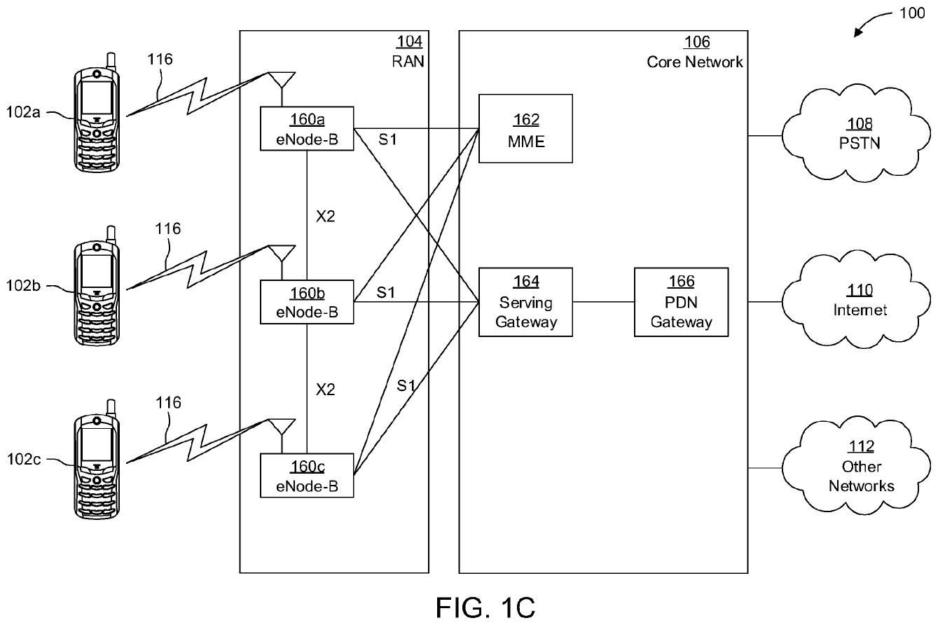

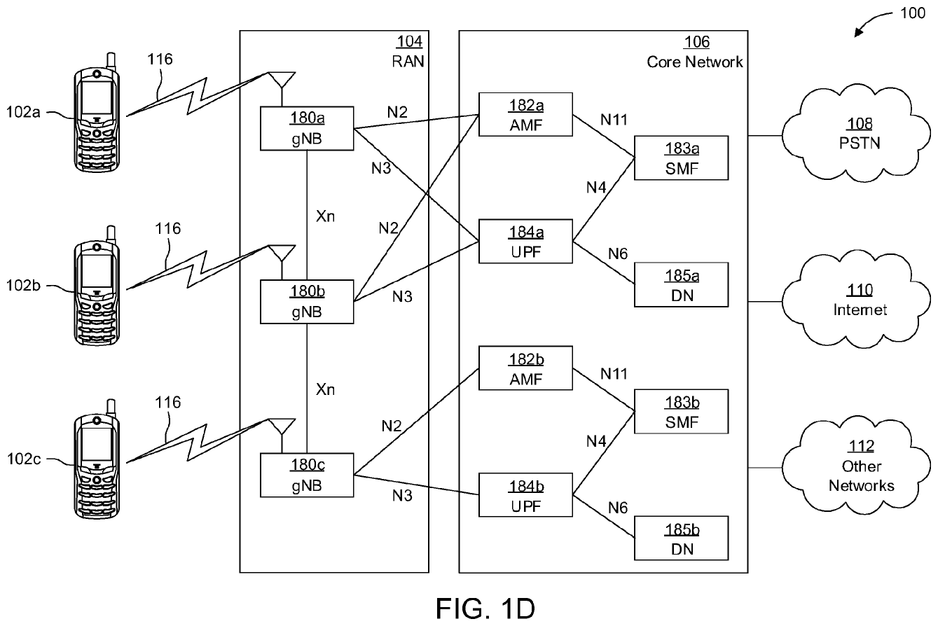

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

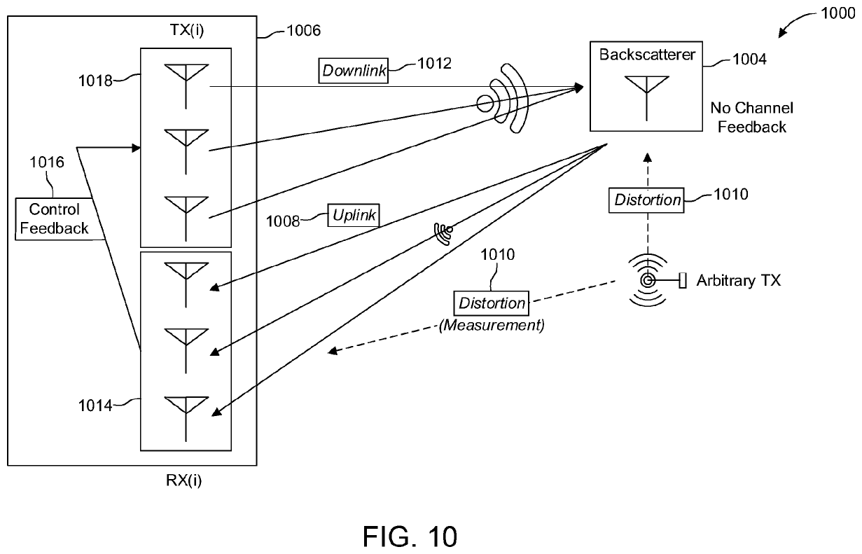

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms, among others, are used herein: Access Point (AP); Backscatter Indication (BID); Backscatter STA (BSTA); Clear To Send (CTS); Downlink (DL); Internet Of Things (IoT); Interrogation Signal (INT_SIG); Internet Protocol (IP); Medium Access Control (MAC); Multiple Input Multiple Output (MIMO); Orthogonal Frequency-Division Multiplexing (OFDM); Physical Layer (PHY); Paging Opportunity (PO); Power-Optimized Waveform (POW); Power Save Mode (PSM); Restricted Access Window (RAW); Request To Send (RTS); Target Wakeup Time (TWT); Wake-Up Receiver (WuR); Wake-Up Packet (WuP); Radio Access Technology (RAT); Radio Front-end (RF); Request To Send (RTS); Station (WiFi device) (STA); Transmit/Receive (TX/RX); Transmission Information Map (TIM); User Equipment (UE); Uplink (UL); and Zero-energy (ZE).

Both IEEE and 3GPP include power saving features for end-user devices (e.g., 802.11 STA, 3GPP UE) e.g., that acquire services from an access device (e.g., 802.11 Access Point (AP) or a 3GPP eNB). It is noted that STA and UE are used as example end-user devices herein, but that any suitable end-user device is useable in place of these examples. It is also noted that AP and eNB are used as example access devices herein, but that any suitable access device is useable in place of these examples. A device effecting power saving features can be referred to as operating in a power save mode (PSM). Typical PSM procedures include the end-user devices negotiating a sleep cycle with the access device, sleeping (e.g., entering the PSM) per the sleep cycle, waking up per pre-negotiated conditions (e.g., periodicities or event occurrences), indicating buffered data for reception or transmission after entering a “wake period”, performing data transmission or data reception during the “wake periods” and resuming PSM (e.g., when there is a lull in data transmission or reception). In some cases, a cyclic, finite but relatively longer duration of time can be considered a “wake cycle” and a portion within that cycle can be considered the “wake period” of the end-user device.

If a device is woken, the duration within the wake cycle during which the device is active may depend on the amount of data pending in queues for reception or transmission. In some cases, after the end-user device wakes, the end-user device may remain active through the entire duration of the wake cycle. If during the “wake period” there is no indication of pending data for reception and/or transmission, the end-user device may resume sleep (e.g., resume the PSM) at the end of the wake period. A PSM is typically entered for energy conservation purposes. In some cases, the longer a device can sleep, the longer the standby time of the power source of the end-user device.

Newer versions of the 802.11 specifications have incorporated a target wake-up time (TWT). TWT implementations may include a function that permits an AP to define a specific time or set of times for individual stations to access the medium. The STA and the AP may exchange information that indicates an expected activity duration to allow the AP to control the amount of contention and overlap among competing STAs. The use of TWT may be negotiated between an AP and a STA. In some implementations, TWT involves a restricted access window (RAW). A RAW facilitates partitioning of the stations within a Basic Service Set (BSS) into groups, e.g., by restricting channel access only to stations belonging to a given group during a particular period of time (referred to as the RAW). In other words, only a certain STA or group of STAs (or other devices) is allowed to access the channel during the RAW. In some cases this has the advantage of reducing contention and/or avoiding simultaneous transmissions from many stations.

In some implementations, STAs that are grouped within a RAW contend for access slots to gain access to the medium. Access slots are restricted to a specific STA, and are time periods within the RAW which may be selected for channel access by the certain STA or group of STAs. In some implementations, the amount of contention for access slots is proportional to the number of STAs grouped within the RAW and call model requirements per STA on average. The term call model refers to a process that can be applied to STAs that determines session arrival (the time that data arrives), an association duration and data requirement per session. In some cases, TWT may be used to reduce network energy consumption, e.g., by facilitating a STA sleep state until their TWT arrives.

The features mentioned above may typically be implemented to provide power saving for a STA. Such STAs can be incorporated into any suitable devices, such as Internet of Things (IOT) devices. Example IOT devices include chemical sensors (e.g., oil leak sensors, fume detectors etc.), environmental monitors (e.g., temperature and/or pressure sensors, embedded seismic monitors etc.,) and event reporting meters (e.g., parking meter expiry, electricity usage reporting etc.) Such devices may have relatively low data rate requirements (e.g., relative to typical 802.11 STAs) and may transmit bursty data traffic (e.g., on the order of 100 s of bits/sec to a few kilobits/sec, e.g., once a few hours/days or even once in a few weeks.)

Such devices may remain in a PSM mode most of the time, may wake up to perform tasks (e.g., periodic monitoring) and may, at designated times, engage in wireless data communications to report information (e.g., measurements or other data) to a server. Such IOT sensors may be deployed in inaccessible places (e.g., wall-embedded seismic monitors, such as are used in in the state of California and in Japan to estimate earthquake damage) where replacing a power source in those devices at periodic intervals would be impractical. Accordingly, devices that can harvest energy from various power sources and use that power reserve for transmit and receive functions may have the advantage of prolonging usability. Devices that are capable of harvesting energy to power their RX and TX chains may become more common in the future. Architectures that involve less power hungry transmit chains may also become ubiquitous in the future. In some implementations, backscattering transmitters support such architectures.

Backscattering is a technique in which a STA, WTRU, or other wireless communications device uses an incident RF signal/waveform to (a) harvest the energy required to power its uplink transmissions; and/or (b) modulate a reflected/backscattered RF signal/waveform via a set of antenna loads. In some implementations, the term backscattering does not necessarily involve energy harvesting, however some implementations may define energy harvesting as part of backscattering. Backscattering typically involves reflecting or absorbing an incident waveform to mimic on-off keying. It is noted that different implementations involve variations on the backscattering concept. For example, the incident waveform, which can be referred to as an interrogation signal, carrier generator etc., may be provided specifically for the purpose of backscattering (i.e., dedicated for backscattering), or may be a signal that is not provided specifically for the purpose of backscattering (i.e., for opportunistic backscattering). Dedicated interrogation signals may be provided by any suitable source, such as a STA, UE, AP, nodeB, WTRU, etc. Such sources may be referred to as dedicated sources. Opportunistic interrogation signals may include any suitable signal that is not provided specifically for backscattering, by any suitable source, such as ambient sources (e.g., Wi-Fi, TV signals, etc.), and signals from other devices that are not provided specifically for backscattering (e.g., STA, UE, AP, nodeB, WTRU, etc.). Such sources may be referred to as opportunistic sources.

There is significant interest in the areas of power save and energy efficiency driven by increased focus on sustainability. For example, a prevalent ambient source is Wi-Fi. In some implementations, it is preferable to backscatter using sources that can be integrated into an existing framework, e.g., to enable widespread adoption. In other words, in some implementations, it is advantageous for legacy devices that do not backscatter and devices that can backscatter to coexist in an environment without disrupting the legacy devices, and/or requiring updates to legacy device software or hardware.

Some implementations include existing, new, or repurposed messages or other signals. Some example messages are defined herein using specific names, however it is noted that the specific names are exemplary only. Some implementations include suitable signals having different names, which provide the same, similar, or overlapping functionality.

In some implementations, a Backscattering Station (BSTA) is a device which can transmit information by backscattering a signal. In some implementations, a BSTA may include an ultra-low powered device, or Zero Energy device. In some implementations, a Clear To Send Type A (CTSA) message may be used as a response, from a receiver back to the initiator, indicating successful reception of RTSB and acceptance of the request to initiate communication as indicated by the RTSB (ready/request-to-send signal). In some implementations, CTSA defers the BSTA from transmission responsibilities indefinitely. In some implementations, CTSA is addressed to a single initiator and the same message assigns a shortened identity, which may be referred to as a mnemonic, to the initiator. In some implementations, if a BSTA has not received a CTSA, the BSTA may be forced not to transmit a RTSB later.

In some implementations, a Request to Send Type B (RTSB) message is transmitted by a BSTA requesting opportunities for backscattering. In some implementations, an RTSB message includes a duration field or other indication specifying a requested duration for backscattering, and/or a flag, which may be referred to as a Backscatter Indicator flag, indicating that it can only backscatter. In some implementations, the receiver responds with CTSA to the initiator of the message (i.e., the BSTA transmitting the RTSB) accepting the request.

In some implementations, a Clear To Send Type B (CTSB) message may be transmitted as a response to a RTSB. In some implementations, the receiver responds using a CTSB message to force all BSTAs to back-off from requesting initiation of backscattering transmissions (i.e., refrain from transmitting/sending transmission requests (RTSBs) for a certain period of time). In some implementations, a CTSB message is sent to a broadcast address. In some implementations, the CTSB may be part of a back-off mechanism based on an existing back-off mechanism (e.g., already in use in the 802.11 framework, e.g., back-off methods in a Distributed Coordination Function (DCF).)

In some implementations, a Backscatter Indication message (BID) message is transmitted by an AP to one or more identified BSTAs. In some implementations, the BID is addressed to the BSTAs based on their shortened identity (e.g., mnemonic). In some implementations, a BID message is sent to BSTAs that have earlier sent an RTSB to the AP and who were deferred with a CTSA. In some implementations, a BID message is sent to BSTAs that are expected (e.g., a priori) to wake-up during a certain time, for example, due to TWT configuration. In some implementations, a BID message indicates a backscatter duration, which may or may not be equal to the duration requested in RTSB.

In some implementations, an AP transmits a Buffer Status Report Request (BSR REQ) to a BSTA to direct it to send a BSR to the AP. In some implementations, the specific BSTA is addressed by a nominal 6-byte MAC address. In some implementations, BSTAs are not directly addressed; rather, the BSTA is addressed to a broadcast address. In some implementations, (e.g., to limit the number of responses and control access to the medium, or determine (i.e., filter) the content of the buffer status report), the AP may also include a mask and/or a K bit value (i.e., a value that can be used by the AP to indicate to the BSTA to include only certain content in the buffer status report), by which the BSTAs filter their responses.

In some implementations, a Buffer Status Report (BSR RPT) is transmitted by a BSTA in response (e.g., as a solicited response) to a BSR REQ. In some implementations, a BSR RPT is transmitted by a BSTA upon solicitation (e.g., after receiving a BSR REQ) regardless of whether the BSTA's data buffer has any content. In some implementations, if the buffer is non-zero valued, the BSTA indicates a quantized buffer status in the BSR RPT, e.g., keeping certain bits (e.g., the MSB N bits (e.g., 4 bits)) to 0. In some implementations, if the buffer is zero-valued, the BSTA indicates a link quality metric in the BSR RPT instead, e.g., keeping certain bits (e.g., the MSB N bits (e.g., 4 bits)) set to 1. In some implementations, the AP interprets the MSB N bits to detect whether the BSR is valid (i.e., includes buffer status) or whether the BSR reflects link quality for the BSTA.

In some implementations, a Clear BID (CLR BID) message is transmitted by the AP to BSTAs to clear mnemonics assigned to one or more of the BSTAs. In some implementations, the AP includes a list of one or more BSTAs to which mnemonics have been assigned, and BSTAs on the list clear their mnemonic. In some implementations, the AP does not specify a receiver mnemonic in the CLR BID message, and all BSTAs receiving the CLR BID message clear their mnemonic.

In some implementations, a BID short ACK (BIDA) is a shortened block acknowledgement to one or more BSTAs to which mnemonics have been assigned. The short block ack is a hexadecimal representation where each bit position represents an ACK or a NACK to the corresponding mnemonic matching their exact position in the header. In other words, a short block ACK 0xFA refers to ACK for all mnemonics except for BSTAs in index 8 and 6.

In some implementations, an Interrogation Signal (INT_SIG) (also referred to as a carrier wave (CW)) is any electronic signal that is sent to a receiver to trigger a particular response. In the backscattering context, in some implementations, the INT_SIG is a signal the receiver can use to backscatter information to some intended recipient. In some implementations, an AP, nodeB, WTRU, or other suitable device transmits an INT_SIG for backscattering by another device, such as a STA, UE, WTRU, or other suitable device.

In some implementations, a BSTA is capable of backscattering, e.g., on an UL, e.g., based on an ambient or dedicated signal, such as an INT_SIG or CW.

In some implementations, an existing field (e.g., a duration field) in an existing frame (e.g., an 802.11 MAC frame) may be overloaded, e.g., using spare fields in the existing frame or by signaling values in an existing field of the existing frame that are not specified in the standard. This may have the advantage of providing backward compatibility, e.g., since the definition of the frame format does not change. In some implementations, older devices will see a valid frame but with values that cannot be deciphered whereas newer devices will see a valid frame and decipherable values.

In some implementations, a mnemonic is a temporary replacement identity for a more permanent identity. For example, in some implementations, transmitter address (TA) mnemonic is a temporary replacement identity for a transmitter, and a receiver address (RA) mnemonic is a temporary replacement identity for a receiver. In some implementations, the RA mnemonic and the TA mnemonic may be the same for a device. In some implementations, the mnemonic is shorter than the permanent identity. In some implementations, this has the advantage of lower signaling overhead. In some implementations, the mnemonic is unique during a lifetime where the AP considers the mnemonic valid. In some implementations, the device that assigned the mnemonic (AP in this example) is responsible for ensuring that the mnemonic is non-colliding (i.e., is not used by more than one device served by the same AP). In some implementations, the assignee is responsible for resolving ambiguities regarding which device is addressed by a mnemonic in cases where the mnemonics are colliding (i.e., are used by more than one device served by the same AP).

In some implementations, an Organizationally Unique Identifier (OUI) is an identifier (e.g., the first 3 bytes of the MAC address) which identifies an organization, such as a manufacturer, uniquely. For example, in some implementations, an Aruba™ device has the first 3 bytes of any MAC address of a device manufactured for Aruba (e.g., original design manufactured (ODM), original equipment manufactured (OEM) or self-manufactured) set to an Aruba OUI. The Aruba OUI, for example, is different to, for example, Cisco™ or MediaTek™ OUIs.

In some implementations, an epoch is a term which refers to a finite, cyclic, duration in time which is maintained, e.g., by an infrastructure node. In some implementations, the infrastructure node may apply similar functions (or execute similar functions) during each epoch in a well-defined network (i.e., a centralized network with a central controller, such as an AP or infrastructure node). In some implementations, an epoch is a time frame that the infrastructure node can apply to execute regular functions without letting functions run to completion. In other words, In some implementations, an epoch allows the infrastructure node to preempt and regain system resources even if certain tasks cannot be completed within the epoch. In some implementations, pending activities can wait to take place in the next epoch in some cases.

In some implementations, a trice is a variable sub-unit within an epoch. In some implementations, an epoch includes a number (e.g., T) of trices. In some implementations an infrastructure node allocates a trice for one activity and another trice for another activity. For example, a single trice may be dedicated, optimized, or otherwise designated for energy harvesting by BSTAs served by the infrastructure node. In some implementations, the determination and assignment of each trice to an activity that can be performed by the served STAs is implementation specific. In some implementations, the determination and assignment of each trice to an activity that can be performed by the served STAs is done by the infrastructure node (i.e., the AP in this context).

Some implementations include backscattering in an 802.11ah framework. In some implementations, a backscattering device (which may be referred to herein as a backscattering STA or BSTA) makes use of various aspects of the 802.11 specifications to perform uplink transmissions.

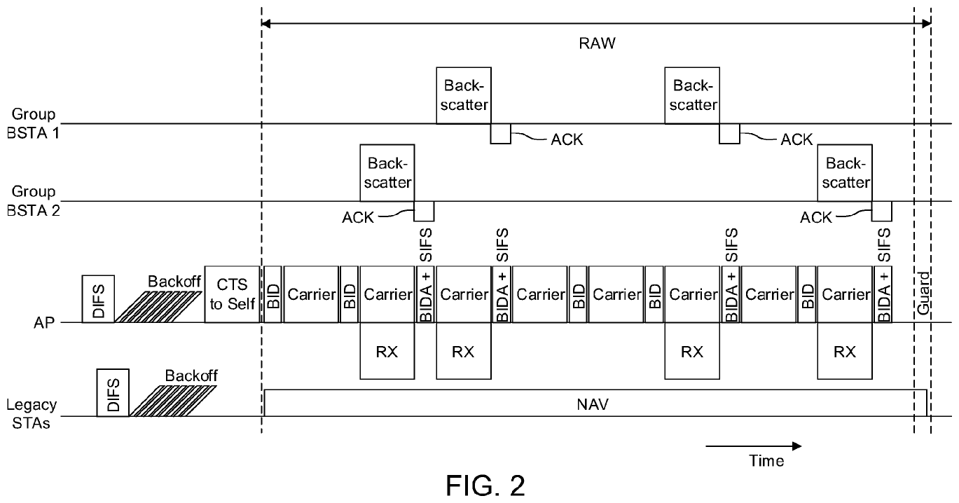

FIG. 2 is a chart illustrating example backscattering in 802.11ah framework. FIG. 2 illustrates messages in an exemplary network that includes an AP, a plurality of legacy STAs (i.e., STAs that are not configured to backscatter) and a plurality of backscatter STAs grouped into groups 1 and 2 (BSTA1 and BSTA2). In the figure, a block above a line associated with an entity represents transmission by the corresponding entity and a block below the line represents reception by the corresponding entity.

Though not explicitly shown, the BSTAs 1 and 2 may or may not be configured with TWTs, and may be grouped by the AP such that they have a set of restricted access slots (e.g., contiguous or non-contiguous) within a RAW window. In some implementations, the BSTAs are made aware of the slots and their respective RAW and/or periodicity of RAW, if any at the time of creating the association. In some implementations, the BSTAs that have a TWT may be configured to sleep until the start time of the TWT. In some implementations, such BSTAs may skip reading some beacons (e.g., beacons that are outside of the TWT window and/or wake duration). Some BSTAs may not have a TWT configured and such BSTAs may receive beacons periodically and may also be configured with RAW slots during the time of association.

The AP maintains the wake-up schedule for all devices configured with TWT and that are associated with it. In this exemplary FIG. 2, prior to the onset of RAW window, the AP gains access to the medium by performing the necessary contention resolution and sending a CTS-to-self, indicating to the devices that the medium is occupied for a duration as indicated in the CTS-to-self. FIG. 2 illustrates example modifications that can be made on top of an existing network (e.g., supporting IEEE 802.11ah) to enable backscatter communications.

In FIG. 2, the AP senses the medium during a back off period following a DCF interframe space (DIFS), and then transmits a CTS-to-Self message. In some implementations, the legacy STAs also sense the medium during a DCF interframe space (DCFS), and back off.

After the AP transmits the CTS-to-Self, the legacy STAs set their NAV vectors based on reception of the CTS-to-Self from the AP, which indicates a time period during which the medium will be busy. The BSTAs seek opportunities that may exist within the legacy STAs' NAV for backscattering.

In this example, BSTAs that have TWT configured may wake-up within the time frame marked as RAW in FIG. 1. Other BSTAs that do not have TWT configured may seek read the beacon and look for receive opportunities for either themselves or for other BSTAs/STAs in the neighborhood.

In either case, to facilitate the BSTAs, the AP transmits a BID message indicating the identities of one or more BSTAs, and an associated duration. In some implementations, the AP can trade off between the amount of contention that will exist when it sends a BID. Accordingly, in some implementations, the AP may restrict the BID message and signal only as many BSTA identities as will achieve the desired amount of contention and/or only as long a duration as will achieve the desired amount of contention. For example, in some implementations, if only a few BSTAs can be indicated in the BID message (e.g., due to BID message size limitations), then the AP will keep the backscattering opportunities to a smaller duration so that it can provide opportunity to an orthogonal set of BSTAs the next time it transmits a BID message.

In some implementations, more frequent BID messages transmitted by the AP may result in more channel overhead, but may effectively reduce the contention rate, e.g., due to the AP is targeting a narrower set of BSTAs.

In FIG. 2, the AP is shown effectively as operating in-band full duplex in the sense that it transmits a carrier wave (marked as Carrier) as an INT_SIG for the BSTAs to backscatter and receives the backscattered signal from the BSTA. It is noted that in some implementations this type of operation is not necessary, e.g., where the AP uses another transmit-receive point (TRP), antenna, or other entity, or ambient RF signals, to provide the INT_SIG for the BSTAs to use, and the AP can receive the corresponding backscattered signals.

In some implementations, if the AP has configured TWT on at least some of the BSTAs, e.g., anticipating the possibility of some BSTAs transmitting within the RAW, the AP gains access to the channel and transmits an INT_SIG. In some implementations, the interrogation signal is used by the backscattering STAs (BSTA1, BSTA2) to transmit uplink data to the AP. It is noted that in some implementations those BSTAs with TWT configured may also contend for resources, e.g., only within their designated RAW slots.

In some implementations the BSTAs that do not have TWT configured will perform DCF, however, since the channel has been secured by the AP earlier (e.g., by CTS-to-self), the BSTAs may treat the channel as busy for a duration set by NAV vector. However, in some implementations, if a CTS-to-self is sent by the AP, the BSTAs may ignore the CTS duration and may seek backscattering opportunities. To facilitate backscattering, in some implementations, the AP may alternate transmitting Backscattering Indication (BID) messages and the INT_SIG. This is reflected in FIG. 2, e.g., where Carrier and BID alternate. In some instances (e.g., as shown), after the AP receives one or more backscattering transmissions, it may send a BIDA instead of a BID message to acknowledge the backscattering transmission or transmissions. The BIDA message may be followed by a short inter-frame space (SIFS) duration and a guard interval may be introduced between consecutive RAWs. Each time the BID is transmitted, the identities of one or more of the backscatter STAs may be indicated in the BID message. In some implementations, if no identity is indicated in the BID message, the AP allows any BSTA to transmit on the opportunity. In some implementations the AP may do so if it decides that the probability of contention is nil or low (e.g., if contention is below a threshold contention). In some implementations the BSTAs are identified in the BID message indication by shortened mnemonics (e.g., as described above) rather than the full 6-byte MAC addressing scheme.

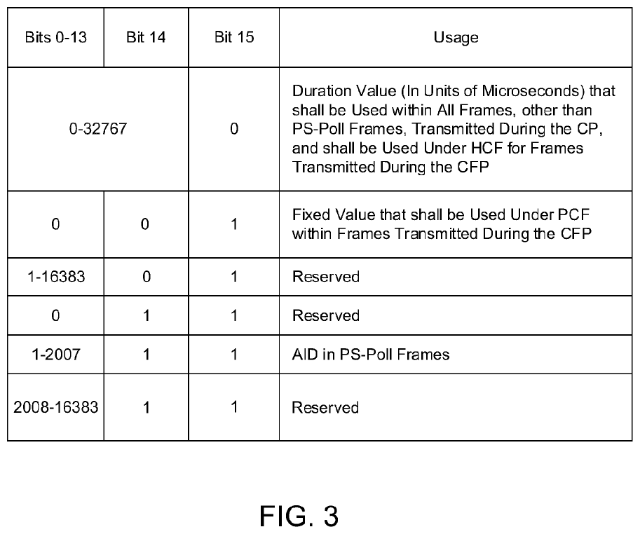

FIG. 3 is a table describing an example format of the BID message. In some implementations, the BID message is modelled after the 802.11 management message. For example, 802.11 MAC messages have a 2-bit Type and a 4-bit Control Sub Type field. Thus, in this example, there are 16 possible Control Sub Types. The 16 Sub Types have been maximally utilized already in the 802.11 specifications and it is not possible to add a new Sub Type. In some implementations however, it is possible to overload a specific Sub Type by interpreting other fields in the 802.11 MAC header.

The table of FIG. 3 reflects section 8.2.4.2 of the 802.11 standard, describing a Duration/ID field, usable in some implementations as a format of the BID message. In some implementations, the fields shown in FIG. 3 are used instead of the duration/ID field in an 802.11 management frame. Per the 802.11 standard, the Duration field is 16-bits, and 2-bits are reserved. Further, the 14 bits that are usable are not all defined. In the 802.11 specifications indicate that any value not on the table may be ignored by the STAs, or that a NAV vector of maximum duration will be set upon reception of a MAC payload with uninterpretable duration (e.g., a value not included in the table). Thus, in some implementations, it is possible to specify and/or add new entries into this table such that newer devices that conform to newer versions of the standards will interpret them correctly whereas older devices that are not upgraded to the newest version of the standard will ignore the MAC frame (or due to an uninterpretable Duration Field.

Some implementations enable backscattering using MAC frames in 802.11. The example duration field shown in FIG. 3 is exemplary, and other fields are not precluded. For example, it is possible to overload or use alternative and/or unused fields to accomplish the same or similar goals.

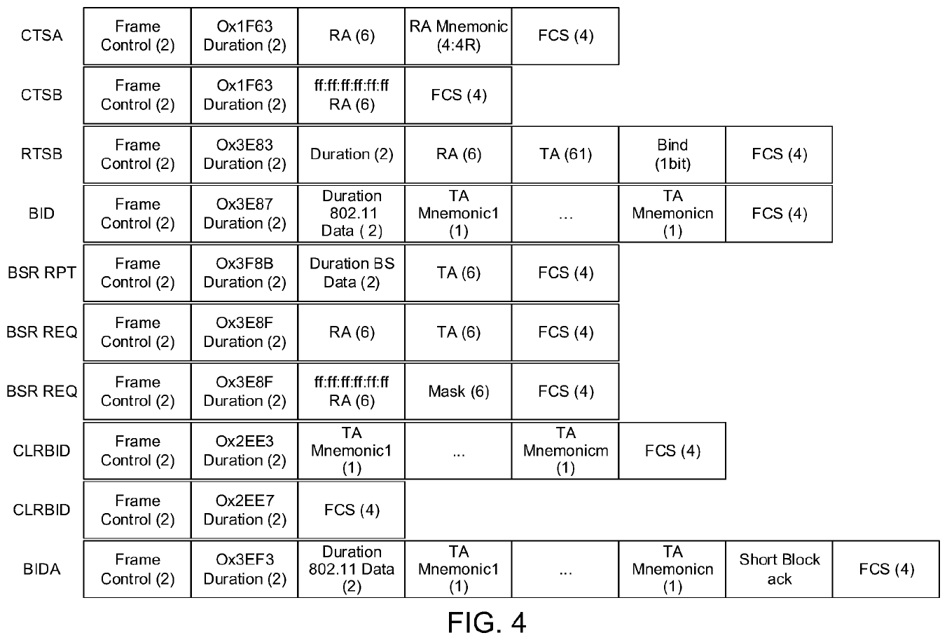

FIG. 4 identifies several example messages (e.g., as described herein) which may be usable by STAs capable of applying backscattering principles within an 802.11 framework in some implementations. Each example message includes example fields, and an indication of an example length of each field in bytes (indicated in parenthesis). Such devices may implement a latest version of the 802.11 specification in some implementations. If an implemented 802.11 version incorporates backscattering techniques, e.g., as described below, in some implementations the backscattering STAs may interpret the messages (e.g., by interpreting the duration field) correctly and may share the medium with legacy STAs which ignore or interpret the messages in a default manner as indecipherable or undefined (e.g., by setting a NAV of maximum duration as discussed herein).

The example values in the example duration field of the example BID shown in FIG. 4 include a value (0x3E87, in this example) that is “newly” specified (i.e., is not defined in earlier versions of the 802.11 standard), and thus legacy devices will ignore this MAC message, or interpret the MAC message in a default manner, such as setting a maximum length NAV. In some implementations, if the AP determines that other STAs require UL transmission resources, or if the AP determines to transmit an INT_SIG to facilitate backscattering for the BSTAs, the AP may transmit a BID message that includes an actual (i.e., is defined in earlier versions of the 802.11 standard) 802.11 duration value (e.g., field number 3 “Duration 802.11 data”, after the new Interpretable Duration field).

In some implementations, when a STAs associates with an AP, the AP assigns a shortened address (e.g., 1 byte) to the device (e.g., during or at the time of association) if the STA indicates backscattering capability. The shortened address may be referred to as a TA mnemonic. In some implementations, the BID message includes one or more Transmitter Address Mnemonics (e.g., TA mnemonic1 (1) . . . TA mnemonic (1) in FIG. 4) which may include a hashed value or a shortened value of the 6-byte TA MAC address.

In some implementations, the TA mnemonic is 1 byte, but with not all bits in use. In other words, the “actual TA mnemonic” or identifying portion of the TA mnemonic may be less than one byte in length in some implementations. For example, in some implementations, the AP may reserve some of the TA mnemonic bits (e.g., non-identifying bits) for future use. In some implementations the TA mnemonic is a temporary identity for the BSTA that is uniquely identifiable when in session. The term session here refers to a particular duration of time during which a device participates in data communications. In some implementations, the AP coordinates the assignment of the TA mnemonic such that the AP is aware of the identity of a BSTA that is being addressed or with which it is in communication (e.g., in TX and/or RX).

For example, in some implementations a full set of N BSTAs in the system may be grouped into M smaller groups with (K=N/M) BSTAs per small group. The K BSTAs may be assigned one or more slots within a RAW window with an example size of K<=256. In this example, the AP may assign a TA mnemonic for each BSTA in the smaller group and make it unique within the smaller group, but the same TA mnemonic can be reused in other smaller groups since the BSTAs do not wake up outside of their TWT, for example. In some implementations, the size of the TA mnemonic is such that the MAC frame size is not too large for devices to decode (or, e.g., to conveniently decode, or decode within a threshold time or decode using less than a threshold amount of resources) a MAC frame with several mnemonics (e.g., a MAC frame of a threshold size). In some implementations, several TA mnemonics can be signaled concatenated in the same MAC PDU and the BID message would be interpreted by each receiving TA mnemonic. In some implementations, BSTAs that are not configured with TWT may contend and access the media at any time; thus, they are not confined by a TWT. For such BSTAs, the AP may reserve a subset of K mnemonics, or the AP may address them using the long format.

In some implementations, e.g., as illustrated in FIG. 2, devices that are 802.11ah compliant participate and obtain service from the AP. In some implementations, the AP and the BSTA devices can interpret the newly specified values in the duration field and interpret the messages differently from non-BSTA devices. In some implementations, DL and UL transmissions with the BSTA occur within the framework of the 802.11ah network.

FIG. 4 is a block diagram illustrating example messages and associated formats according to some implementations. In some implementations, these messages are control subtype messages. Since the subtype is 4 bits, in some implementations, it is not possible to define new control subtype messages in 802.11. Accordingly, in some implementations, the duration field (a 16-bit value) is modified to specify how the message payload is to be interpreted. For example, in some implementations, if the subtype is control and the duration field is set to hexadecimal 0x1F63, then the message is interpreted as CTSA with the format as shown in FIG. 4. The messages illustrated in FIG. 4 are discussed above, and also discussed at appropriate locations throughout this document.

FIG. 4 illustrates an example CTSA frame, CTSB frame, RTSB frame, BID frame BSR RPT frame, BSR REQ frame, two example CLRBID frames, and a BIDA frame.

The example CTSA frame includes a frame control field, duration field, RA field, RA mnemonic field, and FCS field. The frame control field is used to identify the IEEE802.11 frame type and sub-types, the duration field is used to define backscattering specific frame formats, the RA field indicates the receiving STA address, and the RA mnemonic field is an assigned short length address for the receiving STA with address RA. The FCS (Frame check sequence) is used for error detection. As shown, these fields are in the first, second, third, fourth, and fifth positions within the frame, respectively. These example fields are 2 bytes, 2 bytes, 6 bytes, 4 bytes, and 4 bytes long, respectively. It is noted that in some implementations, a CTSA frame includes other fields, a subset of these fields, fields of different sizes, and/or orders these fields differently. In some implementations, a frame serving the function of a CTSA frame is referred to by any other suitable name. In this example, the CTSA frame is identified by a duration field as shown with a value of 0x1F63.

The example CTSB frame includes a frame control field, duration field, RA field, and FCS field. As shown, these fields are in the first, second, third, and fourth positions within the frame, respectively. These example fields are 2 bytes, 2 bytes, 6 bytes, 4 bytes long, respectively. It is noted that in some implementations, a CTSB frame includes other fields, a subset of these fields, fields of different sizes, and/or orders these fields differently. In some implementations, a frame serving the function of a CTSB frame is referred to by any other suitable name. In this example, the CTSB frame is identified by a duration field as shown with a value of 0x1F63, and the RA is shown with a value of ff:ff:ff:ff:ff:ff. In this example, the RA value of ff:ff:ff:ff:ff:ff (i.e., all binary ones) indicates a broadcast—i.e., all receivers are addressed). Individual receivers are addressable by this field in other implementations.

The example RTSB frame includes a frame control field, two duration fields, RA field, TA field, Bind field and FCS field. Here, the second duration field indicates the time required to transmit a following frame. The RA and TA fields indicate the receiving and transmitting STA addresses, respectively. The Bind field is a flag that indicates whether BSTA requires an INT_SIG. As shown, these fields are in the first, second, third, fourth, fifth, sixth, and seventh positions within the frame, respectively. These example fields are 2 bytes, 2 bytes, 2 bytes, 6 bytes, 6 bytes, 1 bit, and 4 bytes long, respectively. It is noted that in some implementations, a RTSB frame includes other fields, a subset of these fields, fields of different sizes, and/or orders these fields differently. In some implementations, a frame serving the function of a RTSB frame is referred to by any other suitable name. In this example, the RTSB frame is identified by a duration field as shown with a value of 0x3E83.

The example BID frame includes a frame control field, duration field, duration 802.11 data field, TA mnemonic fields 1−n, and FCS field. Here, the duration 802.11 data field indicates the backscattering opportunity duration for each addressed BSTA identified by TA mnemonic fields 1−n. TA mnemonic fields 1−n indicate assigned short length addresses for the transmitting (i.e., backscattering) STAs. As shown, these fields are in the first, second, third, fourth through sixth, and seventh positions within the frame, respectively. These example fields are 2 bytes, 2 bytes, 2 bytes, 1 byte each, and 4 bytes long, respectively. It is noted that in some implementations, a BID frame includes other fields, a subset of these fields, fields of different sizes, and/or orders these fields differently. In some implementations, a frame serving the function of a BID frame is referred to by any other suitable name. In this example, the BID frame is identified by a duration field as shown with a value of 0x3E87.

The example BSR RPT frame includes a frame control field, duration field, duration BS data field, TA field, and FCS field. Here, the duration BS data field indicates information regarding buffer status or link quality. As shown, these fields are in the first, second, third, fourth, and fifth positions within the frame, respectively. These example fields are 2 bytes, 2 bytes, 2 bytes, 6 bytes and 4 bytes long, respectively. It is noted that in some implementations, a BSR RPT frame includes other fields, a subset of these fields, fields of different sizes, and/or orders these fields differently. In some implementations, a frame serving the function of a BSR RPT frame is referred to by any other suitable name. In this example, the BSR RPT frame is identified by a duration field as shown with a value of 0x3E8B.

The first listed example BSR REQ frame includes a frame control field, duration field, RA field, TA field, and FCS field. As shown, these fields are in the first, second, third, fourth, and fifth positions within the frame, respectively. These example fields are 2 bytes, 2 bytes, 6 bytes, 6 bytes and 4 bytes long, respectively. It is noted that in some implementations, a BSR REQ frame includes other fields, a subset of these fields, fields of different sizes, and/or orders these fields differently. In some implementations, a frame serving the function of a BSR REQ frame is referred to by any other suitable name. In this example, the BSR REQ frame is identified by a duration field as shown with a value of 0x3E8F.

The second listed example BSR REQ frame includes a frame control field, duration field, RA field, Mask field, and FCS field. Here, the Mask field indicates a specific type of BSR report (e.g., a filtered report.) As shown, these fields are in the first, second, third, fourth, and fifth positions within the frame, respectively. These example fields are 2 bytes, 2 bytes, 6 bytes, 6 bytes and 4 bytes long, respectively. It is noted that in some implementations, a BSR REQ frame includes other fields, a subset of these fields, fields of different sizes, and/or orders these fields differently. In some implementations, a frame serving the function of a BSR REQ frame is referred to by any other suitable name. In this example, the BSR REQ frame is identified by a duration field as shown with a value of 0x3E8F, and the RA is shown with a value of ff:ff:ff:ff:ff:ff. In this example, the RA value of ff:ff:ff:ff:ff:ff (i.e., all binary ones) indicates a broadcast—i.e., all receivers are addressed). Individual receivers are addressable by this field in other implementations.

The first listed example CLRBID frame includes a frame control field, duration field, TA mnemonic fields 1−m, and FCS field. Here, the TA mnemonic fields are used to identify the addressed BSTAs using their shortened temporary IDs. As shown, these fields are in the first, second, third through fifth, and sixth positions within the frame, respectively. These example fields are 2 bytes, 2 bytes, 1 byte each, and 4 bytes long, respectively. It is noted that in some implementations, a CLRBID frame includes other fields, a subset of these fields, fields of different sizes, and/or orders these fields differently. In some implementations, a frame serving the function of a CLRBID frame is referred to by any other suitable name. In this example, the CLRBID frame is identified by a duration field as shown with a value of 0x3EE3.

The second listed example CLRBID frame includes a frame control field, duration field, and FCS field. As shown, these fields are in the first, second, and third positions within the frame, respectively. These example fields are 2 bytes, 2 bytes, and 4 bytes long, respectively. It is noted that in some implementations, a CLRBID frame includes other fields, a subset of these fields, fields of different sizes, and/or orders these fields differently. In some implementations, a frame serving the function of a CLRBID frame is referred to by any other suitable name. In this example, the CLRBID frame is identified by a duration field as shown with a value of 0x3EE7.

The example BIDA frame includes a frame control field, duration field, duration 802.11 data field, TA mnemonic fields 1−n, short block ack field, and FCS field. Here, the short block ack field indicates acknowledgement for one or more recently received backscattering transmissions from one or more backscatterers. As shown, these fields are in the first, second, third, fourth through sixth, seventh, and eighth positions within the frame, respectively. These example fields are 2 bytes, 2 bytes, 2 bytes, 1 byte each, ? bytes, and 4 bytes long, respectively. Here, (?) indicates that the length of the short block ack may be dynamic and is dependent on the number of acknowledged backscattered transmissions. For example, in some implementations, the short block ack field is 1 byte long. It is noted that in some implementations, a CLRBID frame includes other fields, a subset of these fields, fields of different sizes, and/or orders these fields differently. In some implementations, a frame serving the function of a CLRBID frame is referred to by any other suitable name. In this example, the CLRBID frame is identified by a duration field as shown with a value of 0x3EE3.

In some implementations, BSTAs that receive a BID message scan for the presence of a Transmitting Address mnemonic (TA mnemonic) in the BID message to determine if they can access the media immediately after SIFS. In some implementations, the TA mnemonic is a 1-byte short address instead of the 6-byte TA MAC address. In some implementations, the TA mnemonic is assigned to the BSTA by the AP in a CTSA message. In some implementations, the BID message indicates, to the receiving BSTAs, the duration that is available for backscattering, e.g., in a “Duration 802.11 data” field. In some implementations, the number of TA mnemonics included in a BID message is between 1 and n. In some implementations, the number of TA mnemonics included in a BID message is controllable by the AP, e.g., depending on how much contention it allows in the network. In some implementations, in a fully scheduled network or in a congested network, the AP may limit the number of TA mnemonics, e.g., to just 1 in a BID message. In some implementations, the BID message is a deferred recognition for transmission by the AP to one of more BSTAs that had requested transmissions earlier but were deferred earlier with CTSA. In some implementations, the AP is implemented with in-band full duplex capability and can receive the backscatter communication. In some implementations, if the reception of a backscatter transmission is successful, the APs transmits the acknowledgement piggybacked with a BID message in a BID acknowledgement (BIDA) message. An example format for the BIDA message is illustrated in FIG. 4. In some implementations, the BIDA is similar to the BID message except that also includes ACKs (e.g., block ACKs) for previously received transmissions.

It is noted that in typical 802.11 systems, CTS and RTS are used to address the hidden-node problem. The hidden node problem occurs where a receiving STA (e.g., a STA transmitting the CTS in this example) is experiencing interference from a nearby STA that is not detected by the transmitting STA (e.g., the STA transmitting the RTS in this example). On a global level, CTS and RTS can be envisaged as mechanisms to poll and reserve the medium, and not necessarily as a mechanism to avoid interference. As discussed herein, CTS and RTS can be conceptualized as a polling and reservation mechanism whereby devices are acknowledged for a corresponding request. It is noted however that CTS and RTS are existing control messages which are not modifiable in the context of an existing 802.11 system. Accordingly, in some implementations, new CTS and RSTS (e.g., CTS Type A (CTSA) and RTS Type B (RTSB) are introduced as overloaded messages over the control format. In some implementations, RTSB includes a BID flag to indicate to the receiver that a transmission requires assistance in the form of an interrogation signal (i.e., INT_SIG or carrier wave) for backscattering. In some implementations, CTSB is addressed to a broadcast address instead of a unicast address.

In current 802.11 networks, the transmitter and receiver addresses (TA and RA) are 6 bytes long. In current examples of CTS and RTS, the TA and RA are singular (i.e., the CTS and RTS are addressed only to a single TA and RA). In some implementations, CTS and RTS create overhead that may not be necessary in some deployments. Accordingly, in some implementations, BID messages may be simultaneously addressed to several TA addresses. In some implementations, a BIDA is a piggybacked acknowledgement message on top of a BID message, with a similar format. In some implementations, legacy addressing in 802.11 networks is via a 6-byte MAC address. In some implementations, the 1^{st} three bytes are OUI and the remaining 3 bytes are the unique addressing under the OUI. In some implementations, the mnemonic is a temporary identity given by the AP to any STA or BSTA.

In some implementations, the mnemonic is a 1-byte value that is assigned to the STA for short term (e.g., below a threshold time or below a threshold number of messages) transactions. In some implementations, the identity is unique within the AP's service area for the duration of a transaction. In 802.11 systems prior to (i.e., not conforming to) 802.11ah, access to the media is via DCF, Enhanced Distributed Channel Access (EDCA) or Point Coordination Function (PCF) in some cases. In some such systems, legacy devices transmit and receive by performing a clear channel assessment and following prescribed methods. In some implementations, such legacy devices are not affected by various changes proposed herein, and are serviced seamlessly by the AP (e.g., do not suffer a negative impact from the changes proposed herein).

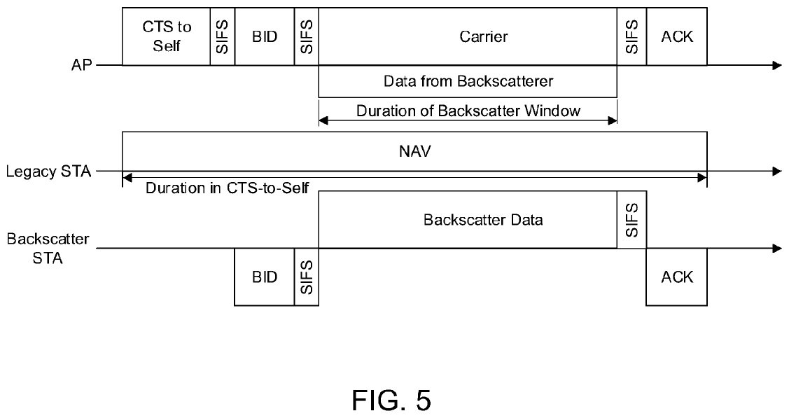

FIG. 5 is a diagram illustrating example backscattering in 802.11 systems. FIG. 5 illustrates messages in an exemplary network that includes an AP, a legacy STA (i.e., STA that is not configured to backscatter or does not support backscatter communications/transmissions) and a backscatter STA. In the figure, a block above a line associated with an entity represents transmission by the corresponding entity and a block below the line represents reception by the corresponding entity.

In the example of FIG. 5, the AP enables backscattering for the backscattering STAs by placing dedicated carriers. After gaining access to the media, e.g., by transmitting the CTS-to-self message shown, the AP indicates to all legacy STAs that the channel will be occupied for the duration indicated in duration field. In this example, the CTS-to-self message is addressed to 0xFF:0xFF:0xFF:0xFF:0xFF:0xFF (i.e., is broadcast to all STAs). The CTS-To-Self transmission forces legacy devices (e.g., the legacy STA shown) to set the NAV vector for the duration indicated in Duration field of the CTS-to-self. In some implementations, this address (i.e., the broadcast address 0xFF:0xFF:0xFF:0xFF:0xFF:0xFF) also indicates to BSTAs (e.g., the Backscatter STA shown) to monitor for backscattering opportunities (i.e., that backscattering opportunities will arise in the near term during the identified duration). In some implementations, the BSTAs monitor for backscattering opportunities by monitoring for a BID, e.g., after a SIFS.

In some implementations, BSTAs search for BID messages at appropriate slot after a CTSB. In some implementations, requests for transmissions are via RTSB and CTSA, even though not explicitly highlighted in the figure (e.g., the transmission of RTSB and CTSA/B may precede what is shown in the figure). In some implementations, CTSA/B are followed by BID messages which are monitored by BSTAs that transmitted RTSB.

In the example of FIG. 5, the Backscatter STA detects the CTS-to-self message transmitted by the serving AP indicating availability of a dedicated backscattering opportunity, monitors the channel for the BID message carrying the backscattering opportunity configuration. In this example, the Backscatter STA detects its identity via a mnemonic in the BID, and receives an associated duration of a backscattering window in the BID. The Backscatter STA contends for the backscattering channel within the identified window; and receives an acknowledgement from the serving AP. In some implementations, the example BTSA includes circuitry configured to, and/or is programmed to perform these actions. In the example of FIG. 5, the backscatter STA obtains the backscattering channel for the duration of the backscatter window, and backscatters data to the AP on the carrier transmitted by the AP for that purpose during the backscatter window. The AP acknowledges receipt of the backscatter data a SIFS after the end of the backscatter window in this example.

In some implementations, knowing the identities of the devices that had transmitted a RTSB and those devices to which a CTSA have been issued, the AP transmits a BID message which is read by BSTAs, and the BSTA that is identified makes use of the INT_SIG (carrier) to backscatter to the AP. In some implementations, the BID message includes an indication of the duration of the backscattering opportunity.

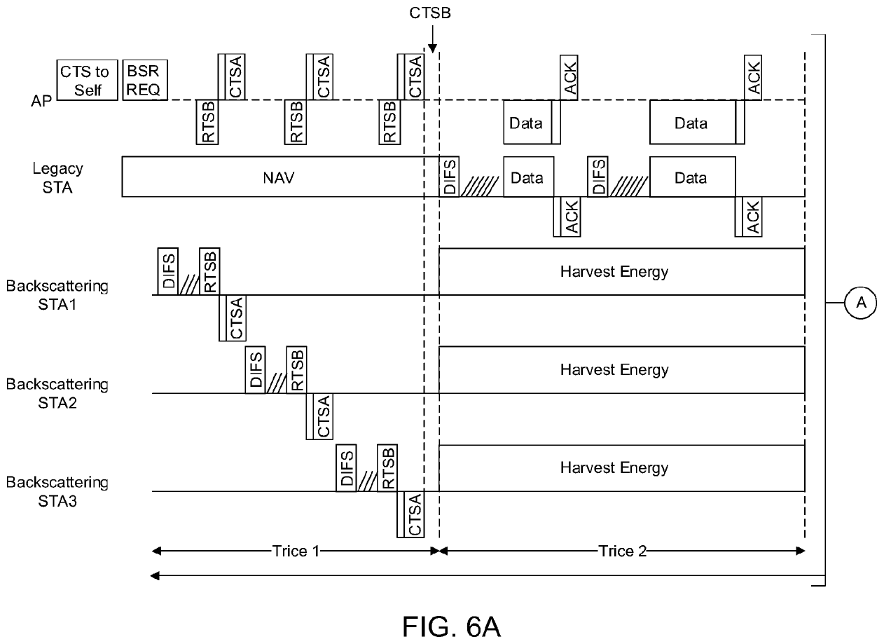

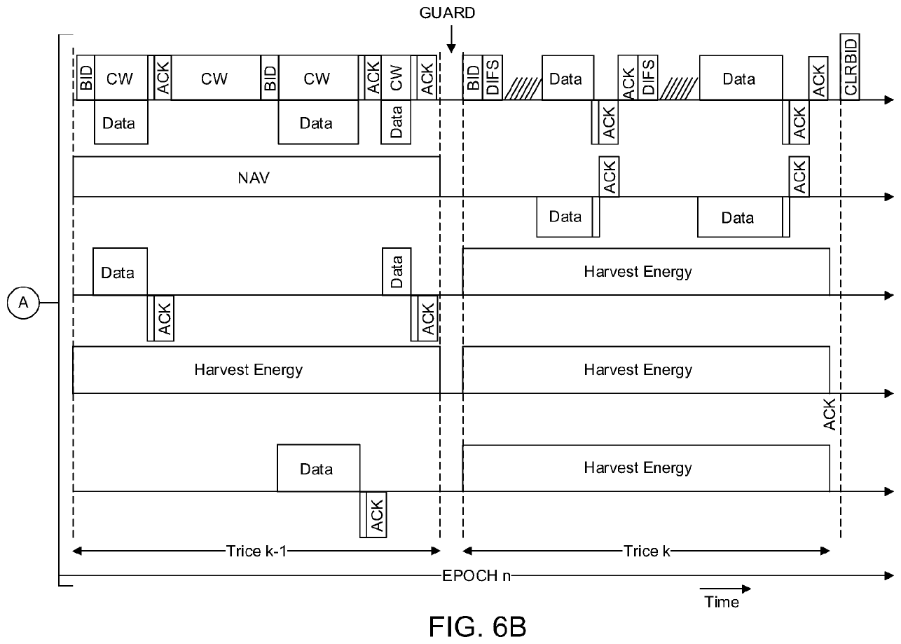

Some implementations include both energy harvesting and backscattering in 802.11 systems. For example, FIGS. 6A and 6B illustrate example energy harvesting and backscattering. FIG. 6B is a continuation of the figure illustrated in FIG. 6A In particular, FIGS. 6A and 6B illustrate an example schema that an AP may apply to enable power optimized devices to both harvest energy from incident signals and to use interrogation signals to backscatter data.

FIGS. 6A and 6B illustrate messages in an exemplary network that includes an AP, a legacy STA, and three backscattering STAs; Backscattering STA1, Backscattering STA2, and Backscattering STA3. In the figure, a block above a line associated with an entity represents transmission by the corresponding entity and a block below the line represents reception by the corresponding entity. It is noted that the messaging in the different trices of FIGS. 6A and 6B is illustrative only, and is not necessarily meant to be interpreted as a time series of events. In other words, FIGS. 6A and 6B are not meant to be interpreted as a cascading sequence of events moving from one trice to another.

In the example of FIGS. 6A and 6B, the AP operates in a cyclic manner defined by one epoch. Each epoch is divided into k time trices. Each time trice t, 1≤t≤k, may be selected for a particular purpose by the AP. Each of the 4 exemplary trices of FIGS. 6A and 6B are discussed below.

In some implementations, the network is deployed to support legacy STAs as well employing various 802.11 protocols, and the AP and BSTAs coexist with these legacy STAs.

FIGS. 6A and 6B illustrate an example epoch n in which the AP has first performed DCF and gained the medium. For example, in time trice 1, it is assumed that the AP has first gained access to the medium by listening to the channel for a DCF interframe space (DIFS) interval and backing off as appropriate.

Epoch n includes four example time trices: time trice 1, time trice 2, time trice k−1, and time trice k. It is noted that an Epoch can include any suitable number of trices. In this example, time trice 1 is usable, e.g., for scheduling transmissions of BSTAs while the legacy STA is blocked by its NAV, time trice 2 is usable, e.g., for transmitting uplink data from a legacy STA while BSTAs harvest energy. Time trice k−1 is usable, e.g., for the BSTAs to transmit the data scheduled in time trice 1 to the AP (or harvest energy, if they do not have data to transmit) while the legacy STA is blocked by its NAV. Time trice k is usable for transmitting downlink data to the legacy STA while the BSTAs harvest energy.

In this example, time trice 1 is used for scheduling transmissions of BSTAs. After the AP gains access to the medium, the AP transmits a CTS-to-self, forcing legacy devices to set their NAV vectors. Thus, the legacy STA receives the CTS-to-self message and sets its NAV based on the CTS-to-self message. In this case, the NAV indicates to the legacy STA that the medium is busy for the duration of time trice 1. In time trice 1 in the figure, NAV indicates that the legacy STA is treating the medium as busy for the entirety of time trice 1, and accordingly, it does not transmit or receive during this time period. The AP subsequently sends BSR REQ messages at appropriate TWTs of the BSTAs. In this example, the AP transmits a single BSR REQ, as shown in the figure. Those BSTAs that have a BSR transmit BSR RPT to the AP. In this example, no BSR RPT is shown, indicating that the BSTAs either do not have a BSR to transmit, or do not have a TWT. In this example, the BSTAs do not have a configured TWT, and thus contend for the channel to transmit a RTSB. In this example, each BSTA performs DCF by waiting a DIFS and backing off (shown by hashed lines) as appropriate, before transmitting a RTSB message.

In some implementations, the BSTAs are low powered devices and transmit these RTSB messages via backscattering to the AP. In some implementations, the RTSB messages are transmitted using a primary transmitter whereas subsequent and/or later uplink transmissions (e.g., main payloads) are backscattered to the AP. In some implementations, such hybrid approaches may have the advantage of providing a significant reduction in the overall power consumption of the device. In some implementations, such hybrid approaches may have the advantage of increasing the resiliency of RTSB transmissions by requesting the AP to provide a reliable access grant to the channel without backscattering, whereas the primary transmissions of payloads are transmitted via backscattering. In such implementations, a similar approach can be applied to avoid or minimize interference from nearby STAs.

In some implementations, the BSTAs backscatter their RTSBs if an available (e.g., coincident) ambient signal is present. In some implementations, the BTSAs do not transmit their RTSBs in the absence of a coincident ambient signal. In this example, the BSTAs have pending data in their buffers and are able to transmit a RTSB without an INT_SIG (e.g., based on an available ambient signal) to indicate a required duration, and whether backscattering needs to be enabled for further transmissions. The RTSB message may also include a Bind flag which indicates to the AP that the BSTA requires an INT_SIG to transmit on the UL.

In some implementations, the AP responds to the BSTAs with a CTSA (e.g., after an appropriate delay, such as a SFIS), e.g., indicating their RA and a RA-mnemonic that will be used for signaling and/or addressing for a temporary duration. In some implementations, the CTSA message defines the RA to RA-mnemonic mapping. In some implementations, the AP assigns a temporarily unique RA-mnemonic and indicates the temporarily unique RA-mnemonic to the receiving BSTA, e.g., in the CTSA message. In some implementations, a BSTA is addressed by the RA-mnemonic, instead of by its full RA. In some implementations, the mnemonic is used by the receiving entity for both transmit and receive functions. In some implementations, the mnemonic identifies the BSTA as either a transmitter (TA-mnemonic) or as a receiver (RA-mnemonic). In some implementations, the CTSA message indicates to the device addressed by the RA (and RA-mnemonic) that its request has been received and queued. In some implementations, the CTSA message does not indicate to the BSTA that it is cleared to send its payload and/or traffic immediately. In some implementations, the AP sends a CTSB message instead of the CTSA message. In some implementations, if the receiving BSTA receives a CTSB message with 0xFF:0xFF:0xFF:0xFF:0xFF:0xFF set as the RA address (i.e., a broadcast), all of the BSTAs back off from transmissions (e.g., for a specified period of time, or until they detect a BID message).

In some implementations, if a CTSB message is transmitted by the AP, the BSTAs attempt to detect BID messages indicating their opportunity to transmit on the UL. If a BID message is received, the BSTAs attempt to detect their RA-mnemonic and to backscatter using the INT_SIG transmitted by the AP. The INT_SIG is shown as Carrier Wave CW in the Figure and illustrated in Trice k−1 of FIGS. 6A and 6B.

In some implementations, a BSTA identifies a high contention environment or hidden-node prone environment (e.g., based on a detected CTS-to-self message and/or a failure to receive CTSA/CTSB for a consecutive number of trials and/or opportunities); utilizes EDCA and the main transceiver to transmit the RTSB message; receives a CTSA/CTSB; determines a RA-mnemonic corresponding to its RA; monitors for and detects a BID which includes its assigned TA-mnemonic and an indication of a backscattering opportunity duration (e.g., indicated by a duration field in the BID); and utilizes a dedicated carrier to backscatter its data at the assigned backscattering window. In some implementations, the example BTSA includes circuitry configured to, and/or is programmed to perform these actions. In some implementations, the backscattering opportunity duration begins when the BID is received and lasts for a time indicated by the duration field. In some implementations, the duration accounts for overhead (e.g., switching, searching, etc., e.g., in terms of inter-frame space).

Time trice 2 is used for scheduling and transmitting uplink data from the legacy STA while the BSTAs harvest energy. After expiration of the NAV set in trice 1, the legacy STA performs DIFS and back off to gain the medium, and then transmits uplink data to the AP, which sends an ACK to acknowledge the uplink data. This repeats in this example. During the scheduling and transmitting of uplink data from the legacy STA, energy present in RF waves on the channel is opportunistically harvested by the BSTAs. In some implementations, a CTSA/B in trice 1 may indicate to the BSTAs that they should back off from transmissions either for a certain period of time or until they detect a BID, and accordingly, the BSTAs will resort to energy harvesting.

Time trice k−1 is used for the BSTAs to transmit the data scheduled in time trice 1 to the AP (or harvest energy, if they do not have data to transmit) while the legacy STA is blocked by its NAV. In this example, the AP transmits a BID which schedules transmissions from the BSTAs, and sets the NAV of the legacy STA. Backscattering STA 1 and Backscattering STA 3 backscatter data to the AP according to the schedule received in the BID, based on a dedicated INT_SIG provided by the AP (referred to as CW in the figure). Backscatter STA 2, which does not have data to send or is not scheduled to transmit data, opportunistically harvests energy present in RF waves on the channel.

Time trice K includes transmitting downlink data to the legacy STA while the BSTAs harvest energy. In this example, the AP transmits a BID which indicates that downlink transmissions will be transmitted to the legacy STA, and indicates to the BSTAs that they should opportunistically harvest energy. After DIFS and back off, the AP transmits downlink data to the legacy STA. The legacy STA transmits an ACK to acknowledge receipt of the downlink data. This repeats in this example. During the transmission of downlink data to the legacy STA, energy present in RF waves on the channel is opportunistically harvested by the BSTAs.

In some implementations, the AP selects particular trices for scheduling downlink messages to legacy STAs. For example, in some implementations certain trices are deterministically better for the BSTAs to harvest energy, which may be indicated in a BID message. In some implementations, the absence of a BID message at the beginning or “top” of the trice indicates to the BSTAs that there may be opportunistic intervals for energy harvesting on that time trice. In some implementations, this is true whether the energy is from DL transmissions from AP to STAs or UL transmissions from STAs to AP. This occurs, for example, in trice 2 and trice k. As noted earlier, the AP assigns mnemonics to address the BSTAs to keep overhead low.

In some implementations, a BSRRPT message is used to report the buffer status of the BSTA. In some implementations, the BSR RPT is 2 bytes but the MSB 4 bits are always set to 0. In some implementations, the BSR is a quantized representation and represented by 12 bits. For example, the value signaled in a BSR RPT may be a truncated value represented mathematically as FLOOR (ACTUAL VALUE in bytes/BSC_SCALAR) where the FLOOR( ) function returns a rounded-down integer value. In some implementations, the BSR_SCALAR is signaled by the AP during association. In some implementations, if the BSTA has no buffered data to transmit, it would need to transmit a zero valued BSR. But instead of transmitting the zero-valued BSR, the BSR RPT contains Quality measurements. In some implementations, the BSTA transmits a Quality report after prefixing the BSR data with 0xF in MSB 4 bits so that the AP understands that the data is not zero valued. In some implementations, the last 12 bits include the measurements such as SINR or RSSI. As mentioned earlier, the mnemonics are temporary and unique within sub-groups until cleared. In some implementations, the AP sends a message (e.g., a CLEARBID message) to all the BSTAs in a sub-group to indicate that the mnemonics previously assigned via CTSA are cleared and addressable. In some implementations, the AP may subsequently assign those mnemonics to other BSTAs in time epoch N+1 for example.

Some implementations include one or more of the following concepts. Some implementations include a device interpreting existing field of media header to determine the backscatter control message sub type. Some implementations include addressing the device by a semi-permanent but locally unique mnemonic (an identity) instead of a permanent identity (e.g., MAC address), where the mnemonic a shortened identity. Some implementations include a device receiving a signal with its mnemonic from the infrastructure node indicating that an opportunity exists for backscattering for specified duration. Some implementations include a device receiving a measurement mask and the device applying the measurement mask on its mnemonic to determine if a report must be sent to the infra node, and the device determining, e.g., based on buffer pending status, whether it should send quality measurements instead. Some implementations include a device receiving a signal to defer UL transmissions for a specific or indefinite duration. Some implementations include a device receiving a time envelope and an indication of the access sub types that are allowed and/or disallowed within the envelope, and the envelope maintaining a certain periodicity. Some implementations include a device receiving a backscatter opportunity and a duration limit in conjunction with indicating the presence of ambient signal sources or dedicated interrogation signal. Some implementations include an AP determining the need to transmit a non-message bearing carrier during specific time or time-period to facilitate backscattering. Some implementations include an AP determining the need to transmit an energy bearing carrier for a specific duration to facilitate energy harvesting.

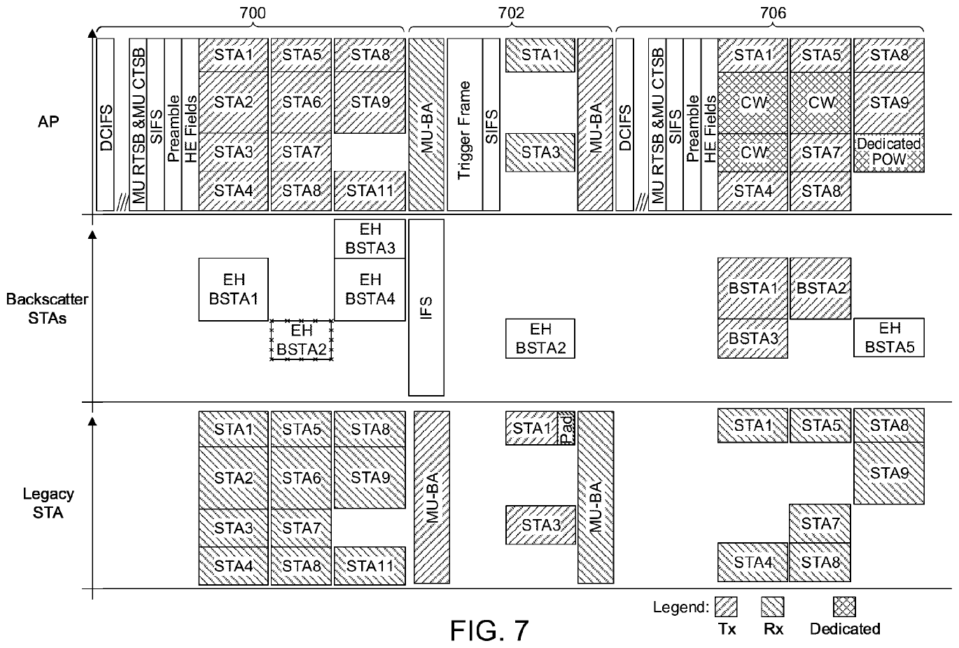

FIG. 7 is a diagram illustrating example multi-user backscattering in an 802.11 OFDMA framework. For example, FIG. 7 illustrates example communications enabling backscatter communications, e.g., for 802.11ax systems. FIG. 7 illustrates messages in an exemplary network that includes an AP, Backscatter STAs, and Legacy STAs.

In FIG. 7, during a first time period 700, the AP first performs DIFS and back off, and then transmits a MU RTSB, and receives a MU CTSB. Scheduling information for legacy STAs are not provided in this frame, but this frame can be used to indicate to BSTAs an EH opportunity as discussed earlier. After a SIFS, the AP transmits a preamble and HE fields (described later) and transmits downlink transmissions to Legacy STAS STA1, STA2, STA3, STA4, STA5, STA 6, STA7, STA8, STA9, and STA11 on downlink resources as scheduled. The legacy STAs receive these signals and transmit a multi-user block acknowledgement (MU-BA) to the AP. During the downlink transmissions to the Legacy STAs, Backscatter STAs BSTA1, BSTA2, BSTA3, and BSTA4 opportunistically harvest energy from RF waves on the channel. After receiving the MU-BA, during a second time period 702, the AP transmits a Trigger Frame, and after a SIFS, receives uplink transmissions from Legacy STAs STA1 and STA3. STA1 pads its transmission to fill the allocated time resources. During these transmissions, BSTA 2 opportunistically harvests energy. The AP transmits a MU-BA to acknowledge the uplink transmissions. After transmitting the MU-BA, during a third time period 704, the AP performs DCIF and back off, and then transmits a MU RTSB, and receives a MU CTSB. After a SIFS, the AP transmits a preamble and HE fields (described later) and transmits downlink transmissions to Legacy STAS STA1, STA4, STA5, STA7, STA8, and STA9, on downlink resources as scheduled. The AP also transmits a dedicated INT_SIG (CW in the figure) and a power optimized waveform (Dedicated POW in the figure). The legacy STAs receive these signals and transmit a multi-user block acknowledgement (MU-BA) to the AP. During the downlink transmissions from the AP, Backscatter STAs BSTA1, BSTA2, and BSTA3 backscatter on the CW signals, and BSTA5 harvests energy from RF waves of the power optimized signal (Dedicated POW). A more detailed description of various techniques involved in FIG. 7 follows.

In some deployments, such as those implementing 802.11ax, DL and UL transmissions are typically controlled and scheduled centrally by the AP. In earlier version 802.11 networks, STAs may access the media by performing contention resolution at arbitrary time slots or within a restricted access window (RAW). In such networks, the AP may seize the medium and preemptively send a CTS to a STA of choice, precluding the need for the STA to perform DCF. In 802.11ax, the AP has greater control of the media and can enable multi-user transmissions on DL and UL.

FIG. 7 illustrates an example implementations where the AP controls DL and UL transmissions while also enabling backscattering communications. It is noted that in the example of FIG. 7, the AP still performs DCF to access the channel and legacy devices can similarly perform the same tasks and claim the media. In this example, the 802.11ax frame starts with the ‘legacy’ preamble for backwards-compatibility. In some implementations, these fields allow older devices to recognize that there is an 802.11 frame on the air. In some implementations, this allows the CSMA/CA protocol to continue functioning in the presence of 802.11ax transmissions. In some implementations, the ‘legacy’ preamble and Repeated Legacy-SIG (RL-SIG) field are transmitted in parallel in all 20 MHz sub-channels used for subsequent transmissions, for backwards-compatibility. In some implementations, the subsequent fields are used for 802.11ax purposes and use a mix of symbol formats, with ‘legacy’ modulation used for low rate fields and for backwards compatibility, while other fields use close subcarrier spacing and longer OFDMA symbols from 802.11ax.

In some implementations, the HE-SIG-A field (High Efficiency SIG) (“HE fields” in the figure) includes information about the packet to follow, including whether it is downlink or uplink, BSS color, modulation MCS rate, bandwidth and spatial stream information, and remaining time in the transmit opportunity, etc. In some implementations, this field has different content for single-user, multi-user and trigger-based frames, and is repeated in the ‘extended range mode’ of 802.11ax. In some implementations, the HE-SIG-B field (also “HE fields” in the figure) is only included for multi-user packets. In some implementations, the HE-SIG-B field includes information common to all recipients, and other fields that are user-specific, so its length depends on the number of users receiving the transmission. In some implementations, if OFDMA is used, the HE-SIG-B client-specific fields are sent concurrently in each sub-channel used for the subsequent packet transmission. In some implementations, the HE-SIG-B is another complex field. In some implementations, it has variable length, depending on the number of clients the AP is addressing, and two different types of information, common and user specific.

In some implementations, the common field (part of “Preamble” and/or “HE fields” in the figure) identifies the structure of OFDMA sub-channels or Resource Units (RUs) that will be used, e.g., 18×26 RU or 2×242 RU. In some implementations, the common field includes other information that is common to all transmissions. In some implementations, several user-specific fields follow the common field. In some implementations, the AP uses these fields to identify how it will be transmitting to each client; e.g., including the number of spatial streams, the MCS it will use and/or whether it will use beamforming. In some implementations, the 802.11ax specification requires the transmitter to form the HE-SIG-B field simultaneously in multiple 20 MHz channels, taking up the total bandwidth of the allocated channel. Thus, if the AP is using an 80 MHz channel, it will transmit 4 HE-SIG-B fields, one in each 20 MHz subchannel.

In 802.11ax, the following terms apply and are also used in this document. Basic Trigger frame: Specifies how and when client devices should respond. Multi-user Block Ack Request (MU-BAR): This trigger frame requests a Block Ack from multiple client devices simultaneously. User Info fields specify the frames that are to be Ack′d. Multi-user Request To Send (MU-RTS): This trigger frame is used to clear the air before a transmission, in the same way as single-user RTS-CTS.

In some implementations, on the DL, the AP schedules the multi-users, fills the HE headers (i.e., he AP determines the content of the preamble/HE fields), and transmits the DL data on the RUs. In some implementations, on the UL, the AP signals to the devices that they have UL grants to utilize. In some implementations, for this purpose, the AP sends a trigger frame and transmits the identities of STAs that have UL grants to utilize. The downlink packets may include ACKs and triggers, and the uplink transmissions may include trigger-based frames which also carry ACKs. In some implementations, all of these signals are controlled and orchestrated by the AP.

In some implementations, to enable backscattering in the 802.11ax framework, the AP transmits a Trigger frame with an Assisted BSR flag and the locations of one or more RUs for Assisted BSR signaling. The AP may periodically send a query to BSTAs to determine the rate of transmissions on the UL and the whether the BSTAs have pending data to transmit.

In some implementations, if the receiving BSTA has pending data in its buffer, it selects (e.g., uniformly randomly) an indicated RU that is marked for Assisted BSR. In some implementations, on the current frame following the Trigger frame, the BSTA transmits a BSR concatenated with its mnemonic on the selected RU if the Assisted BSR flag was set to True. In some implementations, the mnemonic is used for contention resolution since the identity of the BSTA that transmits the BSR is not known (similar to the RACH process). In some implementations, the mnemonic is appended to the quantized BSR and the entire content is scrambled by the mnemonic, e.g., for additional protection.

In some implementations, the AP and/or coordinated TRPs provide the INT_SIG (CW in the figure) on the Assisted BSR RUs for the device to backscatter their BSR. After the BSR has been received from the BSTAs (and from the other STAs that require UL transmission, e.g., using RACH slots), the AP determines the identities of STAs that have UL transmissions to transmit, and matches those opportunities and resource requirement (e.g., RU requirements) with BSR requirements received from BSTAs. If sufficient capacity is available on the next frame, the AP transmits the BSTA mnemonics and the corresponding RU mappings for backscattering on a subsequent Trigger frame. The BID flag may or may not be set to True.

In some implementations, if the BID flag is set to True, the AP has ensured that there will be another STA that will have transmissions on the UL on the set of indicated RUs which the BSTA can use for backscattering. In some implementations, this is the typical case in a reasonably loaded network since the regular STAs have a greater need to transmit and the BSTAs are less likely to have high demand. In some implementations, the BSTAs, receiving a subsequent Trigger frame and a BSTA mnemonic to RU mapping for backscattering and BID flag set to True, will backscatter on the specific RU.

In some cases, the AP determines that there are no regular STAs that have a need to transmit and accordingly, selects one or more TRPs (or antennas) to provide the INT_SIG. In such cases, the AP (or associated TRPs) may allocate any RU for providing a dedicated INT_SIG, and is not limited to specific RUs that would be allocated for the UL transmission of a specific STA. In some implementations, the AP transmits a subsequent Trigger frame and a BSTA mnemonic mapped to one or more RUs for backscattering, and sets the BID flag to indicate that the BSTA can select any RU and is not limited to specific RUs. In this scenario, the BSTA selects (e.g., uniformly randomly) a RU that is mapped to its mnemonic for backscattering.

In some implementations, the AP receives energy statistics from the BSTA within the UL transmissions, which may indicate that the BSTA needs to harvest energy. In some implementations, the AP may be operating on a larger bandwidth (e.g., larger than a single 20 MHz channel). In some implementations, the AP transmits, e.g., in the Common Field within HE-SIG-B field the BSTA mnemonic, an index to one or more 20 MHz subchannels that is assigned to the BSTA, an index to energy bearing RUs, and a time schedule. In some implementations, the time schedule may indicate a start time offset and duration and may imply a possible periodic service. In some implementations, the AP may indicate that the power optimized waveform (POW) time schedule is periodic, or the AP can determine a different schedule for POW delivery and cancel the currently valid time schedule. In some implementations, if the AP indicates these in the Common field in HE-SIG-B header, it applies to any BSTA that may want to consume that opportunity. In some cases, the periodic POW may be too infrequent, and the BSTA may require a dedicated POW opportunity. In some implementations, the BSTA may in such cases receive, from the AP, an index to one subchannel, an index to energy bearing RUs, a start time offset, and/or duration of the dedicated POW opportunity, e.g., in a user-specific field within an HE-SIG-B field, along with a mnemonic of the BSTA.

In some implementations, the AP may need to determine whether a BSTA and participating devices have the capability to filter out interference in the event that the BSTAs are to backscatter over regular downlink transmissions. In some implementations, the AP may determine, e.g., based on device capabilities, whether a dedicated INT_SIG (CW in the figure) is needed, rather than opportunistic piggy-back transmissions over regular traffic.

For example, in FIG. 7, after performing DIFS and back off, the AP sends a Multi-user RTSB (MU-RTSB) to indicate the STAs to which a DL will be sent. STAs indicate acceptance by transmitting a MU-CTS, MU-CTSA, or MU-CTSB (not shown). The AP schedules High efficiency multi-user transmissions to the STAs using OFDMA and/or MIMO paradigms. The transmissions occur on one or more resource units (RU) for the various STAs covering the operational bandwidth. The transmissions are opportunistically used by the BSTAs to harvest energy, as shown in FIG. 7.

In some implementations, the BSTA opportunistically utilizes UL transmissions on a channel to backscatter its own transmission, e.g., based on measured signal strengths. For example, in some implementations, a BSTA receives a BID message indicating availability of DL and UL assisted backscattering opportunities and includes a corresponding configuration (e.g., the configuration optionally including measurement filtering rules), measures DL received signal strength (e.g., based on the received BID message, the preamble in a DL frame, and/or a dedicated reference signal), applies filtering rules on the measured DL received signal, determines that the received signal strength is below a first threshold, receives a trigger frame and/or a corresponding BID message from the serving AP and determines RUs eligible for opportunistic UL-assisted backscattering and corresponding plurality of common or STA specific measurement thresholds (e.g., including a lower 2nd threshold and/or an upper 3rd threshold determines one or more sub-thresholds between the 2nd and the 3rd thresholds (e.g., based on the desired QoS requirement), measures sub-band and wide-band received signal strengths on the eligible RUs during a first portion of the UL frame, or alternatively measures sub-band and wide-band received signal strengths on the eligible RUs during a prior UL frame or prior UL frames transmitted by the same STAs, based on desired QoS requirement selects one or more RUs with measured signal strengths falling between two consecutive sub-thresholds within the lower 2^{nd} threshold and the upper 3^{rd} threshold, and transmits and/or reflects on the selected RU or RUs using backscattering techniques. In some implementations, the example BTSA includes circuitry configured to, and/or is programmed to perform these actions. Since backscattering here is based on an UL transmission, to ensure that the received backscattered signal at the AP is of reasonable strength, in some implementations the BSTA selects an RU (e.g., and a corresponding transmitting STA) with a measured signal strength above a lower 2nd threshold. In some implementations, to reduce collision amongst BSTAs, the BSTA may limit RU selection to those satisfying a received signal strength below the upper 3rd threshold.

Since the transmissions are OFDMA, certain tones are transmitted with higher power than other tones. Accordingly, in some implementations, the AP may indicate to the BSTAs (e.g., in a trigger frame or a scheduling frame) which RUs are optimal for energy harvesting for appropriate BSTAs in the MU-RTSB. Depending on harvesting need, in some implementations, the BSTAs may harvest energy from information and power bearing RUs meant for other STAs.

In some implementations, the AP sends a trigger frame with a schedule of transmissions on the UL and associated STA identities. In some implementations, the schedule may also allow for random access opportunities on the UL. The UL transmissions from the STAs are energy bearing and the BSTAs may use them to perform energy harvesting.

In some implementations, the AP enables DL and backscattered-UL transmissions at the same time by employing in-band full duplex communications.

In some implementations, a BSTA receives a BID message indicating the availability of DL and UL assisted backscattering opportunities and a corresponding configuration, including a DL-assisted backscattering first threshold, a configuration including a first threshold, or configuration including a lower first threshold and one or more additional thresholds above the lower first threshold and an associated QoS for each additional threshold; determines a second threshold larger than or equal to the first threshold (e.g., based on the desired QoS requirement); measures DL received signal strength (e.g., based on the received BID message, the preamble in a DL frame, and/or a dedicated reference signal); determines the received signal strength above the lower 1st threshold or based on desired QoS determines the received signal strength to be above the additional thresholds above the lower 1st threshold; selects one or more RUs of a DL frame for backscattering from the set of eligible RUs determined (e.g., based on the received BID message and/or the preamble in the DL frame; transmits and/or reflects on the selected RU or RUs using backscattering techniques; In some implementations, the example BTSA includes circuitry configured to, and/or is programmed to perform these actions. In some implementations, an AP performs an in-band receive operation on the received RUs via self-interference cancellation. In some implementations, the configuration may include a first threshold which is used by the BSTA to determine whether it should consider DL assisted or UL assisted backscattering. The lower first threshold and larger second threshold may be used to limit contention between BSTA during the selection of RUs based on their required QoS.

In the preceding examples, in some implementations, any of the DL and/or UL signals may be ongoing active transmissions to and/or from STAs served by the AP, e.g., which are opportunistically utilized by BSTAs to modulate their information on top of existing transmissions (e.g., to modulate their information bits on existing carriers and/or RUs that are currently assigned to other STAs). In some implementations, e.g., alternatively, any of the DL and/or UL signals may be dedicated power optimized signal transmissions (e.g., sinusoidal transmissions, sent directly from the AP or requested by the AP in coordination with associated STAs.)

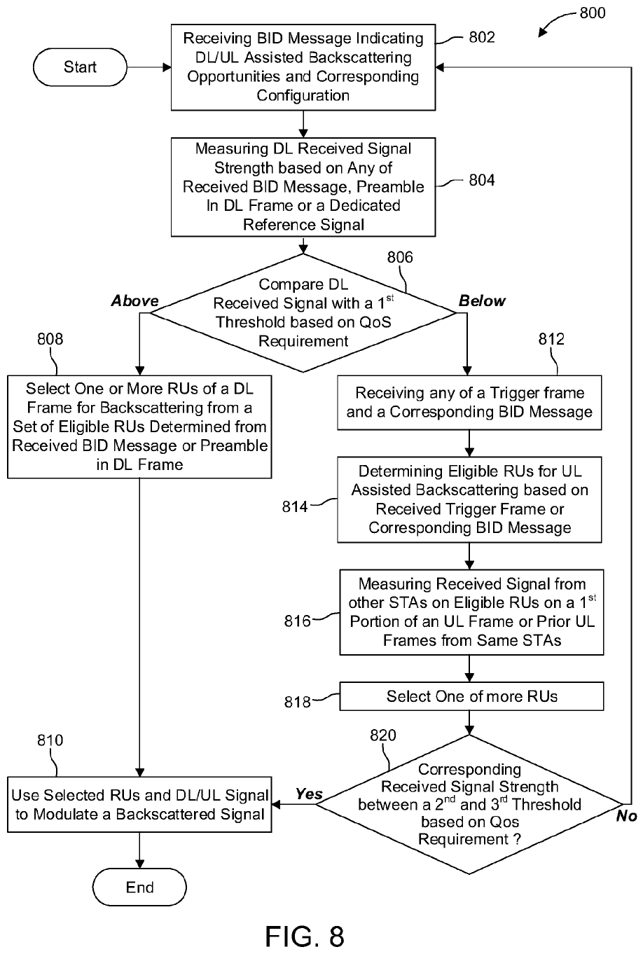

FIG. 8 is a flow chart 800 illustrating example backscattering, e.g., by a BSTA.

In step 802, the BSTA receives a BID message indicating DL and/or UL assisted backscattering opportunities, and may indicate a corresponding configuration. In some implementations, the configuration may indicate signal strength thresholds, RUs eligible for backscattering transmission, and/or UL signal measurement configuration. In some implementations, the configuration includes a first threshold which is used by the BSTA to determine whether it should consider DL assisted or UL assisted backscattering. The lower first threshold (e.g., a 2nd threshold) and higher second threshold (e.g., a 3rd threshold) may be used to limit contention between BSTA during the selection of RUs based on their required QoS, as further discussed herein.

In step 804, the BSTA measures a received signal strength of a DL signal which may potentially be used for backscattering. In some implementations, the DL received signal strength is determined based on the received BID message, a preamble in the DL frame, or a dedicated reference signal.

On condition 806 that the DL received signal strength exceeds a threshold (e.g., a threshold associated with a quality of service (QoS) requirement for the backscatter transmission), the BSTA selects one or more resource units (RUs) of the DL frame for backscattering in step 808. In some implementations, the RUs are selected from a set of eligible RUs. In some implementations, the BSTA determines the set of eligible RUs based on the BID message, a preamble in the DL frame, or in any other suitable manner.

In step 810, the BSTA modulates the DL signal on the selected RUs to backscatter a signal.

On condition 806 that the DL received signal strength does not exceed the threshold, the BSTA waits to receive a trigger frame or a further BID message in step 812.

In step 814, the BSTA determines one or more eligible RUs of an UL frame for backscattering. In some implementations, the RUs are selected from a set of eligible RUs. In some implementations, the BSTA determines the set of eligible RUs based on the trigger frame or BID message, or in any other suitable manner.

In step 816, the BSTA measures received signal strength of UL transmissions from other STAs on the eligible RUs. In some implementations, the BSTA measures the received signal strength of the UL transmissions during a first portion of the UL frame, or bases the measurement on earlier measurements of prior UL frames from the same STAs.

In step 818, the BSTA selects one or more of the eligible RUs of the UL frame, e.g., based on the measured received signal strength.

On condition 820 that the UL received signal strength exceeds a threshold (e.g., a threshold associated with a quality of service (QoS) requirement for the backscatter transmission), the BSTA modulates the UL signal on the selected RUs to backscatter a signal. Otherwise, the flow returns to step 802. In some implementations, this condition evaluates the UL signal strength which should fall between a 2nd and 3rd threshold (e.g., because the STA is unaware of the location of the source of the UL transmission.)

Flow chart 800 illustrates operation of a BSTA where a DL received signal is above or below a first threshold based on a QoS requirement In some implementations, if there are no eligible RUs meeting the criteria during the current transmission interval, the BSTAs fall back to future opportunities during which backscattering opportunities may arise.

The M U-RTSB indicates the schedule of DL for the STAs on specific RUs and indicates to the BSTAs the specific RUs that are INT_SIG. The DL transmissions to STAs on specific RUs are not interfered with. The interrogation signal INT_SIG on the specific RUs (shown as CW) is used by the BSTAs to backscatter to the AP. The AP performs in-band reception on those specific RUs. The AP transmits a power optimized waveform (POW) dedicated towards a BSTA.

Some implementations include one or more of the following concepts. Some implementations include a device receiving a Trigger frame and contention opportunity signal within the trigger frame, indices to one or more time-frequency resources for indicating backscattering requirement. Some implementations include a device uniformly randomly selecting a time-frequency resource (e.g., a RU) to transmit a contention based backscattering request. Some implementations include a device transmitting, on the current frame following the Trigger frame, a transmission request concatenated with its Mnemonic on the selected time-frequency resource. Some implementations include an AP providing an interrogation signal on the time-frequency resources or an AP securing ambient sources (e.g., other STAs receiving on DL from AP) on the indicated contention-based time-frequency resources. Some implementations include an AP determining identities of non-backscattering devices that have DL transmissions and matching those opportunities and resource requirements with transmission requirements received from Backscattering devices. Some implementations include devices receiving a subsequent Trigger frame and a mnemonic to resource mapping and a backscattering flag set to True. Some implementations include backscattering devices backscattering on the current frame following the Trigger frame on the specific RU mapped to its mnemonic. Some implementations include a backscattering device receiving, in a Common Field in a header, an index (or indices) to one or more energy bearing frequency resources, and a time schedule. In some implementations, the time schedule indicates a start time offset and/or duration. Some implementations include a backscattering device receiving, in a User-specific Field of the 802.11 header along with its mnemonic, an index to energy bearing resources and a time schedule. Schedule containing start time offset and duration.

Some implementations include backscattering in OFDMA networks. In 802.11 frameworks that use CDMA-based waveforms, it may be easier to backscatter because the number of different codeword types that are used are very few and that knowledge can be taken advantage off when backscattering a CDMA incident waveform. However, most deployed 802.11 networks use OFDM waveforms, and it is difficult to backscatter a modulated waveform such as OFDM since much information is unknown. Nevertheless, it is possible to enable backscattering in a OFDM framework.

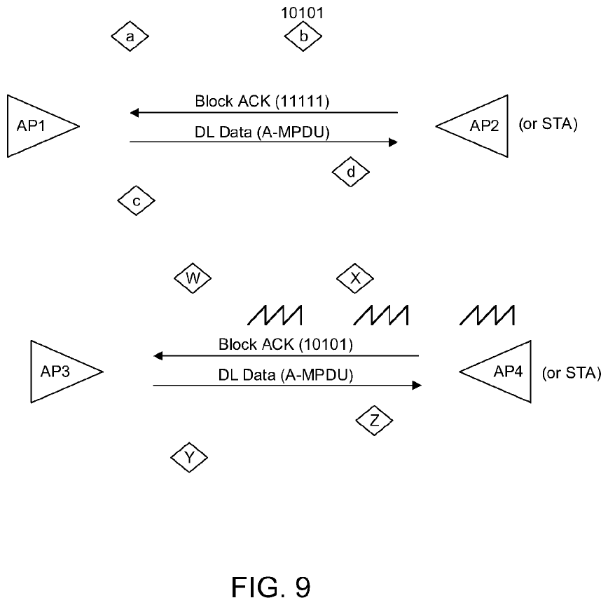

FIG. 9 is a system diagram shows two example systems, illustrating different aspects of backscattering. The topmost system includes BSTAs a, b, c, d, and APs AP1, and AP2. In this example, BSTA b has a bitstream 10101 for transmission to AP1. AP1 (e.g., using techniques described herein) determines a schedule of when BSTA b is required to transmit on the UL, and transmits DL data (A-MPDU) to a participating, coordinated AP (AP2) by forming aggregated MAC PDUs (A-MPDUs) with fixed, smaller payload sizes and associated CRC. AP2 transmits a block ACK 11111 to AP 1. In some implementations, this approach is appropriate for low-rate reliable backscattering. In some implementations, during the transmission of the DL Data (A-MPDU) by AP 1, BSTA b uses backscattering to constructively or destructively interfere with the transmission received by AP 2 (i.e., based on the information block it needs to deliver to AP 1). Subsequently, the received block ACK by AP 1 from AP 2 should effectively carry the information block from BSTA b (e.g., unless the channel had already corrupted some of the MPDUs).

The bottommost system includes BSTAs w, x, y, z, and APs AP1, and AP2. In this example, BSTA x has a bitstream 10101 for transmission to AP3. To backscatter the bitstream, BSTA x causes interference, or avoids causing interference, in the DL data from AP3 to AP4, in proportion to the duration of each MPDU in the A-MPDU. In this example, the channel is changed sufficiently during the time BSTA x needs to signal a 1 and the channel is left unmodified during the time the BSTA needs to signal a 0. The zigzag lines represent these periods (e.g., of one MPDU duration) when the channel is left uncorrupted and a space between the dark zigzag lines (e.g., of one MPDU duration) indicates when the BSTA corrupts the channel. The intermittent interference to the channel carries the information payload 10101 that BSTA intends to transmit to AP3. In this example, AP4 demodulates the DL A-MPDU and finds CRC pass for 1^{st}, 3^{rd} and 5^{th} MPDUs and CRC failure for 2^{nd} and 4^{th} MPDUs. AP4 sends a block ACK to AP1 (indicating 10101) which AP1 interprets as backscattered data from BSTA b.

In this example, bi-static backscattering is enabled, e.g., taking advantage of a multitude of legacy STAs that may exist in the network without a need to modify them. In some implementations, the backscattering data itself may include a FCS or CRC field, e.g., to ensure that STA's failure to detect was due to deliberate interference and not deteriorated channel conditions. In some implementations, this is applicable in practice only when the BSTA is close enough to the legacy STA to cause significant destructive interference. In some implementations, deployment scenarios exist where this is practical.

In some implementations, a BSTA detects a CTS-to-self message indicating a dedicated backscattering opportunity and determines that a received signal strength is below a first threshold; monitors UL transmissions of nearby STAs and detects a received signal strength from a first STA that is above a second threshold; utilizes the main transceiver to send an RTSB requesting bi-static transmission to the first STA; receives confirmation and bi-static backscattering opportunity configuration (e.g., including information on number of MPDUs within an A-MPDUs addressed to the first STA); determines a total number of information bits (e.g., inclusive of overhead bits) available for transmission based on the number of MPDUs available within the A-MPDU and the number of backscattering opportunities either being singular or multiple; utilizes the bi-static backscattering opportunity configuration to modulate the DL signal by causing destructive interference to specific MPDUs and/or constructive interference to remaining MPDUs within the A-MPDUs transmitted to first STA, wherein each success or failure at the reception of an MPDU corresponds to a backscattered bit-1 if ACK or a backscattered bit-0 if NACK from the BSTA. In some implementations, the example BTSA includes circuitry configured to, and/or is programmed to perform these actions.

The example of FIG. 9 illustrates an AP transmitting to a coordinating AP at a time instance where there is no DL data destined for any STA. However in FIG. 9, the coordinating AP (e.g., AP2 or AP4) could also represent a STA. In an example case where there happens to be coincidental data to the STA, In some implementations, AP3 can transmit to the STA and the BSTA performs the same procedures as above. In this case, in some implementations, the STA sends a block ACK showing CRC failure for two MPDUs within the A-MPDU, and in some implementations, AP3 retransmits that information to the STA. It is noted that in some implementations, this use case covers BSTAs with a very low transmission rate, and a very infrequent need to backscatter. In such cases, in some implementations, intentionally causing interference to the channel in order to enable backscattering results in an extremely minimal increase in retransmission rates, and is negligible as an overhead. In some implementations, it can be shown that this approach is sufficient to support systems with several STAs and a few coordinating APs to support IOT sensors (which are BSTAs) that have minimal data rate requirements. In some implementations, the resulting aggregate system capacity is not reduced significantly, and the STA count supported by the AP also increases significantly.

FIG. 10 illustrates an example system 1000 configured to determine DL channel conditions via reverse estimation. In the example of FIG. 10, a low powered BSTA 1004 uses energy harvesting to operate electronic circuitry. Here, BSTA 1004 performs energy harvesting and an AP 1006 determines the harvesting rate of BSTA 1004. To facilitate this, in this example, AP 1006 measures a backscattered uplink 1008 from BSTA 1004 in the presence of distortions 1010 (e.g., potentially deliberate). In some implementations, a downlink interrogating signal 1012 is received by BSTA 1004 with significantly greater power than backscattered uplink 1008. In some implementations, if receiver 1014 on the AP can estimate the downlink incident waveform, then it can implement a control feedback loop 1016 and indicate to the transmitter 1018 of the AP to compensate at the time of transmission.

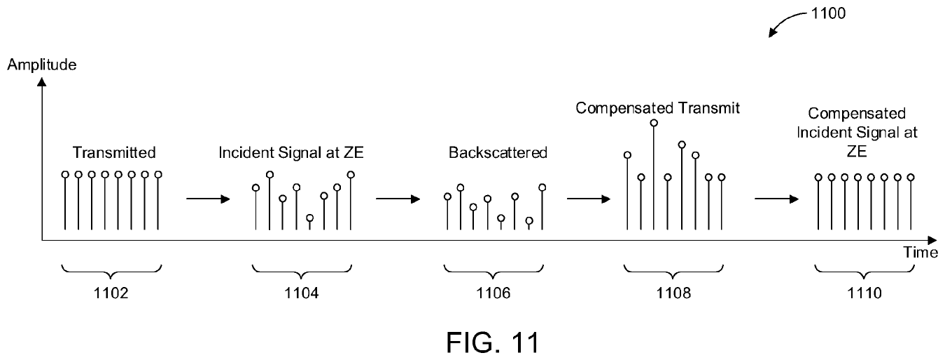

FIG. 11 is a line graph 1100 illustrating example transmit-side compensation of channel impairments. For example, in FIG. 11, the transmitted signal 1102 from the AP is depicted as amplitudes of several tones. Signal 1104 shows the actual incident signal at the BSTA, also referred to as a zero energy (ZE) device (ZE in the figure). It is noted that the incident INT_SIG is received at unequal power levels where the intent is to show frequency selective impairments. If this is the input signal for backscattering, then the actual backscattered signal 1106 is even further deteriorated making communications less reliable. If the AP is able to estimate the incident signal at the BSTA/ZE device, then it can pre-compensate the transmission making the incident waveform at the BSTA arrive at higher quality. The compensated transmit signal 1108 shows the result of the AP pre-compensating the transmit waveform, e.g., based on a capability to reverse estimate the channel. The compensated incident signal 1110 at ZE illustrates the actual incident signal following channel impairments if the compensated transmission had occurred. In some implementations, the approach illustrated in FIG. 11 enables an incident waveform at each ZE by compensating for multipath, distortions that may exist on a non-LOS channel. In some implementations, a control loop is required at the AP to change phase and amplitude by estimating impairments in channel. In some implementations, the AP compensates for varying channel gains by changing the energy harvesting target and/or changing the transmitted waveform. Alternatively, if the AP can estimate the channel impairments, the AP uses predetermined and/or stored waveforms appropriate for channel that represents best waveform. In some implementations, the AP uses specific waveforms that have historically performed the best for specifically estimated channels. In some implementations, stored and/or pre-determined waveforms are used by the AP representing the best waveform if the channel can be reverse estimated satisfactorily.

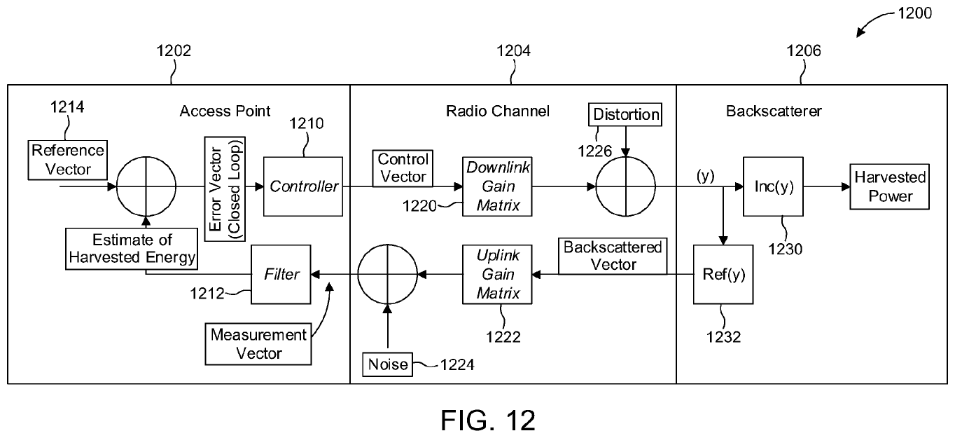

FIG. 12 illustrates an example control loop 1200 implemented at an AP 1202 for channel estimation. AP 1202 includes a controller 1210, and a filter 1212. Controller 1210 selects a waveform to be transmitted over the radio channel 1204 to deliver power to the backscatterer 1206. A reference vector 1214 is input for comparison of an estimate of harvested energy to the reference Ref(y) 1232 encoded by the backscatterer 1204 in the backscattered vector.

The radio channel 1204 incorporates the effects of fading, which are indicated by the downlink gain matrix 1220 and uplink gain matrix 1222, noise 1224, and distortion 1226.

The backscatterer 1206 includes Inc(y) 1230, which accumulates and/or harvests energy in the received signal y, and Ref(y) 1232, which is a reference signal modulated in a backscattered vector on top of the received signal y to aid the access point in performing reverse channel estimation.

In some implementations, compensation is performed at the AP to accommodate changing propagation conditions and distortions that may arise on the radio channel 1204, e.g., due to presence of other devices in the vicinity of the AP. In some implementations, the received waveform at the ZE backscatterer 1206 can be modelled as a linear combination of attenuated control vector and distortions, e.g., as shown in FIG. 12. In some implementations, this allows the AP to make several determinations. For example, the AP may determine to use the RF spectrum as split into constant equal-width subcarriers and/or as variable-width subcarriers. In some implementations, the gain matrices shown in FIG. 12 may be sparse, e.g., because the radio channel 1204 is memory-less and linear. In some implementations, mathematically, because of this, the off-diagonal elements (cross-products between tones) are zero valued.

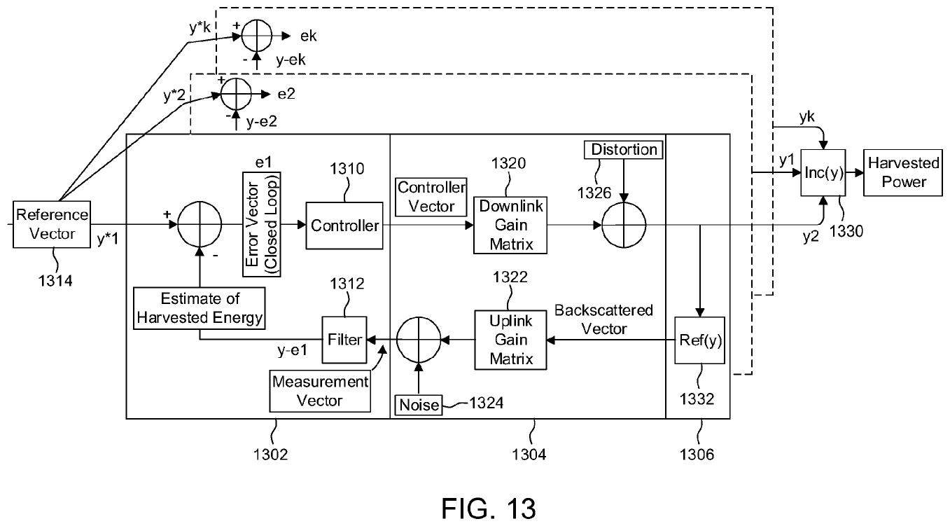

FIG. 13 illustrates an example control loop 1300 for multi-carrier, multi-STA estimation of channel 1304, involving a BSTA 1306.

AP 1302 includes a controller 1310, and a filter 1312. Controller 1310 selects a waveform to be transmitted over the radio channel 1304 to deliver power to the backscatterer 1306. A reference vector 1314 is input for comparison of an estimate of harvested energy to the reference Ref(y) 1332 encoded by the backscatterer 1304 in the backscattered vector.

The radio channel 1304 incorporates the effects of fading, which are indicated by the downlink gain matrix 1320 and uplink gain matrix 1322, noise 1324, and distortion 1326.

The backscatterer 1306 includes Inc(y) 1330, which accumulates and/or harvests energy in the received signals y1, y2, and yk, and Ref(y) 1332, which is a reference signal modulated in a backscattered vector on top of the received signal y to aid the access point in performing reverse channel estimation.

In some implementations, control loop 1300 enables AP 1302 to model the control loop in as decoupled into K subcarriers, one per BSTA. In some implementations, the waveform closed loop tracking system is decoupled with subcarrier tracking. In some implementations, the subcarriers are coupled at BSTA's receiver level via the power harvesting circuitry. FIG. 13 illustrates example multi-carrier extension, where multiple BSTAs can be reverse channel estimated. Thus, in some implementations, a framework is established whereby the AP 1302 can catalog a waveform or pattern and the associated estimated channel, which can be used at a future time. In some implementations, AP 1302 determines whether energy harvesting is needed based on harvesting rate estimation at BSTA 1306. In some implementations, AP 1302 estimates (e.g., autonomously without any feedback from the BSTAs) the energy harvesting rate of BSTA 1306 by reverse estimating the backscattered channel and propagation conditions. In some implementations, AP 1302 implements a control loop to change phase and amplitude of carriers or subcarriers by estimating impairments in a backscattered channel. In some implementations, AP 1302 adaptively compensates for varying channel gains by changing an energy harvesting target. In some implementations, AP 1302 catalogs waveforms appropriate for an estimated channel and uses a set of predetermined or catalogued waveforms appropriate for a currently estimated channel representing a best incident waveform at the BSTA. In some implementations, AP 1302 uses a control vector to determine a RF spectrum split into constant equal-width subcarriers and/or variable-width subcarriers to maximize an energy harvesting rate.

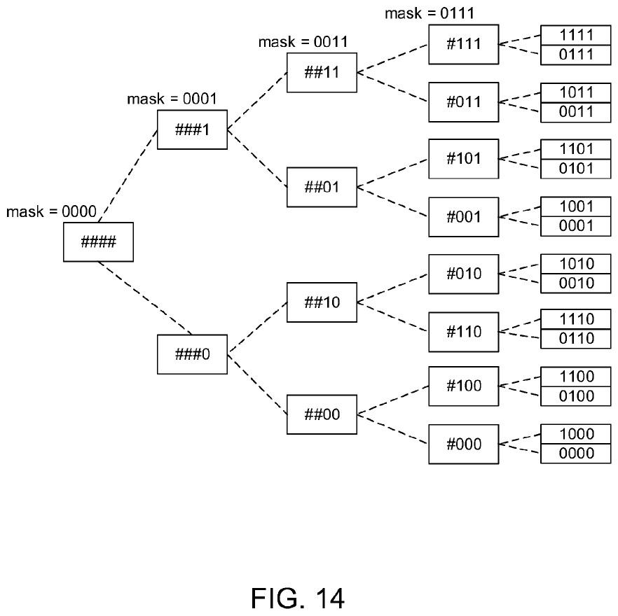

FIG. 14 illustrates example buffer estimation of a BSTA by an AP. FIG. 14 illustrates an example of how a mask may be used to limit the number of individually addressed BSR requests. For example, applying the mask (0011) indicates that the (single) BSR request is addressed to all BSTAs with mnemonics defined under the branch (##11), which includes (1111, 0111, 1011, 0011). Alternatively, if the mask (0111) is applied, the (single) BSR request is addressed only to BSTAs with mnemonics defined under the branch (#111), which includes (1111, 0111).

In some implementations, e.g., as described herein, the AP decides when to control the channel for backscattering transmissions. In some implementations the AP does so by performing DCF, transmitting CTS-to-self, and reserving the media for a duration for BSTA activity. In some implementations the AP determines, in those cases, whether a need exists to secure the media. In some implementations, the AP periodically polls the BSTAs and requests them to transmit buffer status reports. In some implementations, sending a BSR to each BSTA is an overhead, and several BSTAs may have nothing to transmit and have zero bytes in their buffer.

To minimize this, in some implementations, the AP groups the BSTAs into several uniform sets, where in each set, the combined requirement for UL transmissions from BSTAs is approximately equal. In some implementations, this is estimated from historic activity, or based on device capability. In other words, in some implementations the AP facilitates uniform groups, such that no group overwhelms the AP with more backscattering needs compared with the other.

To enable this, in some implementations, the AP assigns mnemonics as detailed in earlier sections. In some implementations, a predetermined number of bits are used as unique identification numbers. In some implementations, a second predetermined number of bits are used for random values which is used by AP for probing. In some implementations, the AP transmits a command requesting each BSTA having random values within a specified group of random values to respond.

In some implementations, e.g., as shown in FIG. 14, an AP transmits an arbitration value, e.g., mask, which may be referred to as Arbit_Val, and BSTAs perform bitwise logical operations to determine a need to respond. For example, in some implementations, if the equation (mnemonic & Arbit_Val)>0 evaluates to “0” (FALSE), then the BSTA will not reply since the arbitration does not involve the BSTA. It is noted that in some implementations the AP can decide on the arbitration value and the previously assigned mnemonics such that no more than N % of the devices will have a simultaneous need to access the medium. In some implementations if the equation evaluates to greater than zero and if the BSTA has data in buffer, the BSTA will transmit a buffer status. In some implementations if the equation above evaluates to greater than zero but the BSTA has no data in buffer, the BSTA will not transmit a buffer status. In some implementations, by performing this in a structured manner, with the number of bits in the Arbit_Val mask increased by one each time, eventually the BSR of all BSTA over a determination interval is known with no collisions. In some implementations, the AP can be configured to employ tree search and Aloha techniques to determine the unique identification numbers.

Some implementations include a device receiving a backscattering window of time and access sub types that are allowed within the envelope, where the envelope maintains a certain periodicity. Some implementations include a device performing a contention-based access request by backscattering an incident signal on a set of time-frequency resources. Some implementations include a device receiving an acknowledgement to defer uplink data transmissions for a future backscattering opportunity. Some implementations include a device addressed by a locally unique mnemonic (an identity) at a future opportunity instead of by a permanent identity (e.g., MAC address), where the mnemonic is a shortened identity. Some implementations include a device receiving a signal and duration limit with its mnemonic from an infrastructure node indicating that an opportunity exists for backscattering for specified duration. Some implementations include a device performing contention free access by backscattering an incident signal on a set of time-frequency resources. Some implementations include a device receiving a measurement mask and applying the measurement mask on its mnemonic to determine if a report is required to be sent to the infrastructure node, where in some implementations, the device determines based on buffer pending status whether it should send quality measurements instead. Some implementations include a device receiving an energy bearing carrier for a specific duration to facilitate energy harvesting.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented in a wireless station (STA), the method comprising:
receiving a backscatter indication (BID) message that indicates a backscattering opportunity and a downlink (DL) signal strength threshold; and
backscattering a DL transmission received on a resource unit (RU) indicated in the BID message to generate a backscatter transmission, based on a signal strength of the DL transmission exceeding the DL signal strength threshold.

2. The method of claim 1, wherein the backscattering of the DL transmission occurs based on a duration of the DL signal exceeding a payload transmission requirement associated with the backscatter transmission.

3. The method of claim 1, further comprising:
backscattering an uplink (UL) transmission from another STA, received on a resource unit indicated in the BID message, to generate another backscatter transmission, based on a strength of the DL transmission not exceeding the DL signal strength threshold.

4. The method of claim 3, wherein the backscattering the UL transmission occurs based on a signal strength of the UL transmission exceeding an UL signal strength threshold, and a duration of the UL transmission exceeding a payload transmission requirement associated with the other backscatter transmission.

5. The method of claim 1, further comprising:
measuring a signal strength of the DL transmission based on the BID message, a preamble in a DL frame, or a dedicated reference signal.

6. The method of claim 4, wherein the DL signal strength threshold and the UL signal strength threshold are a same threshold.

7. The method of claim 1, wherein the BID message comprises a management message.

8. The method of claim 1, wherein the BID message comprises an acknowledgement message.

9. The method of claim 1, wherein the DL signal strength threshold is associated with a quality of service (QoS).

10. The method of claim 1, wherein the backscatter transmission is generated based on a signal strength of the DL transmission exceeding the DL signal strength threshold and the DL transmission exceeding a payload transmission requirement.

11. A wireless station (STA) comprising:
a receiver configured to receive a backscatter indication (BID) message that indicates a backscattering opportunity and a downlink (DL) signal strength threshold; and
a transmitter configured to backscatter a DL transmission received on a resource unit (RU) indicated in the BID message to generate a backscatter transmission, based on a signal strength of the DL transmission exceeding the DL signal strength threshold.

12. The STA of claim 11, wherein the transmitter is further configured to backscatter the DL transmission based on a duration of the DL signal exceeding a payload transmission requirement associated with the backscatter transmission.

13. The STA of claim 11, wherein the transmitter is further configured to backscatter an uplink (UL) transmission from another STA, received on a resource unit indicated in the BID message, to generate another backscatter transmission, based on a strength of the DL transmission not exceeding the DL signal strength threshold.

14. The STA of claim 13, wherein the transmitter is further configured to backscatter the UL transmission based on a signal strength of the UL transmission exceeding an UL signal strength threshold, and a duration of the UL transmission exceeding a payload transmission requirement associated with the other backscatter transmission.

15. The STA of claim 11, wherein the receiver is further configured to measure a signal strength of the DL transmission based on the BID message, a preamble in a DL frame, or a dedicated reference signal.

16. The STA of claim 14, wherein the DL signal strength threshold and the UL signal strength threshold are a same threshold.

17. The STA of claim 11, wherein the BID message comprises a management message or an acknowledgement message.

18. The STA of claim 11, wherein the DL signal strength threshold is associated with a quality of service (QoS).

19. The STA of claim 11, wherein the transmitter is further configured to generate the backscatter transmission based on a signal strength of the DL transmission exceeding the DL signal strength threshold and the DL transmission exceeding a payload transmission requirement.

20. A method implemented in a wireless station (STA), the method comprising:
receiving a backscatter indication (BID) message that indicates a backscattering opportunity and a downlink (DL) signal strength threshold; and
backscattering a transmission received on a resource unit (RU) indicated in the BID message to generate a backscatter transmission, based on a signal strength of a DL transmission;
wherein if the signal strength of the DL transmission exceeds the DL signal strength threshold, the backscatter transmission is backscattered based on the DL signal; and
wherein if the signal strength of the DL transmission does not exceed the DL signal strength threshold, the backscatter transmission is backscattered based on a received uplink (UL) signal.
